(19) United States
(12) Patent Application Publication
(10) Pub. No.: US 2007/0087876 A1
(43) Pub. Date: Apr. 19, 2007

(54) Multi-stage spring for track tensioning system

(76) Inventors: Michael C. Ward, Brampton (CA); John Steven Czving, Brampton (CA)

Correspondence Address: Ralph A. Dowell of DOWELL & DOWELL P.C., 2111 Eisenhower Ave, Suite 406, Alexandria, VA, 22314, US

(21) Appl. No.: 11/377,384

(22) Filed: Mar. 17, 2006

Related U.S. Application Data
(60) Provisional application No. 60/727,878, filed on Oct. 19, 2005.

(51) Int. Cl. F16H 7/08; F16H 7/22

(52) U.S. Cl. 474/110; 474/101; 474/109

(57) ABSTRACT

A multi-stage spring for maintaining tension in a track of a tracked vehicle is provided. The multi-stage spring can urge the idler wheel in a first manner when the vehicle is accelerated or decelerated. The multi-stage spring can urge the idler wheel in a second manner when debris is caught between the track and a wheel on the vehicle. The multi-stage spring can urge the idler wheel in a third manner when the suspension of the vehicle is compressed.

### FIELD OF THE INVENTION

The invention relates to a multi-stage spring and to track tensioning systems for tracked vehicles.

### BACKGROUND OF THE INVENTION

The use of tracked vehicles can be advantageous for numerous applications, due to their improved grip and their ability to travel over relatively rough terrain that would be unsuitable for wheeled vehicles. However, the use of tracks presents several unique challenges. For example, in some situations, the track can inadvertently come off one of the drive or idler wheels on the vehicle, which renders the vehicle undrivable until the track can be re-installed. This event is sometimes referred to as ‘detracking’.

One situation that can cause detracking to occur would be when the vehicle encounters terrain that causes its suspension to compress. Compression of the suspension impacts the effective length of the path taken by the track around the wheels of the vehicle. Compression of the suspension can substantially reduce the effective path length for the track, which the track may not be able to accommodate. At this point, the track may be longer than the path about which it is expected to move, and with the simultaneous application of some side load, detracking can occur. Another situation in which detracking can occur is during acceleration or deceleration of the vehicle. In some situations, skipping of the track on the drive or idler wheels may occur instead of detracking. Skipping of the track can also lead to problems and damage of the track.

Another challenge that exists for tracked vehicles is dealing with debris that passes between the track and one or more of the wheels. When this occurs, the presence of the debris can increase the effective path length for the track. If the track or the vehicle cannot accommodate the increase in the effective path length, the track may become overtensioned and it or some of its associated components may be damaged.

It would be advantageous to provide a tracked vehicle with an improved way of keeping the track on the wheels and keeping the track from incurring damage in such situations during vehicle use.

### SUMMARY OF THE INVENTION

In a first aspect, the invention is directed to a multi-stage spring for a track tensioner for a tracked vehicle. The multi-stage spring has a rest position associated therewith. The multi-stage spring is positionable in a first range of positions, a second range of positions and a third range of positions. The first range of positions is closer to the rest position than is the second range of positions. The third range of positions is closer to the rest position than is the first range of positions. The multi-stage spring is movable from an initial position in the first range of positions in a direction away from the rest position by a first range initial force. The multi-stage spring is movable from an initial position in the second range of positions in the direction away from the rest position by a second range initial force. The first range initial force is greater than the second range initial force. The multi-stage spring is movable in the third range of positions to a third range final position by a third range final force. The first range initial force is greater than the third range final force.

In a particular embodiment of the invention in the first aspect, the multi-stage spring comprises a first piston housing, a first piston and a second piston. The first piston is slidable in the first piston housing. The second piston is slidable. A piston-to-piston chamber is defined between the first and second pistons. The piston-to-piston chamber is filled with a first-and-second-piston force transfer fluid. The first-and-second-piston force transfer fluid is substantially incompressible. The first piston has a chamber-facing side. The first piston housing includes a seat for receiving the first piston. The seat is sized to cover a first selected surface portion of the chamber-facing side when the first piston is received in the seat and to leave a second selected surface portion of the surface area of the chamber exposed to the piston-to-piston force transfer fluid in the piston-to-piston chamber. When the first piston is outside of the seat, both the first and second selected surface portions of the chamber-facing side are exposed to the piston-to-piston force transfer fluid in the piston-to-piston chamber.

In a further embodiment of the invention in the first aspect, the multi-stage spring has a first end and a second end. The multi-stage spring comprises a first biasing means. The first biasing means urges the first piston towards the seat and away from the first end. The multi-stage spring comprises a second biasing means, wherein the second biasing means urges the second piston away from the second end and urges the first piston housing away from the second end.

In a second aspect, the invention is directed to a multi-stage spring for a track tensioner for a tracked vehicle. The multi-stage spring has a rest position associated therewith. The multi-stage spring is positionable in a first range of positions, a second range of positions and a third range of positions. The first range of positions is closer to the rest position than is the second range of positions. The third range of positions is closer to the rest position than is the first range of positions. In the first range of positions the multi-stage spring exerts a resistive force to movement in a direction away from the rest position that increases with distance away from the rest position from a first range initial force to a first range final force. In the second range of positions the multi-stage spring exerts a resistive force to movement in a direction away from the rest position that increases linearly with distance away from the rest position from a second range initial force to a second range final force. In the third range of positions the multi-stage spring exerts a resistive force to movement in a direction away from the rest position that increases linearly with distance away from the rest position from a third range initial force to a third range final force. The first range initial force is greater than the second range initial force and the third range final force.

In a particular embodiment of the invention in the second aspect, the multi-stage spring comprises a first piston housing, a first piston and a second piston. The first piston is slidable in the first piston housing. The second piston is slidable. A piston-to-piston chamber is defined between the first and second pistons. The piston-to-piston chamber is filled with a first-and-second-piston force transfer fluid. The first-and-second-piston force transfer fluid is substantially incompressible. The first piston has a chamber-facing side. The first piston housing includes a seat for receiving the first piston. The seat is sized to cover a first selected surface portion of the chamber-facing side when the first piston is received in the seat and to leave a second selected surface portion of the surface area of the chamber exposed to the piston-to-piston force transfer fluid in the piston-to-piston chamber. When the first piston is outside of the seat, both the first and second selected surface portions of the chamber-facing side are exposed to the piston-to-piston force transfer fluid in the piston-to-piston chamber.

In a further embodiment of the invention in the second aspect, the multi-stage spring has a first end and a second end. The multi-stage spring comprises a first biasing means. The first biasing means urges the first piston towards the seat and away from the first end. The multi-stage spring comprises a second biasing means, wherein the second biasing means urges the second piston away from the second end and urges the first piston housing away from the second end.

In a third aspect, the invention is directed to a track tensioner for maintaining a selected tension in a track on a tracked vehicle, comprising a multi-stage spring that can urge the idler wheel in a first manner when the vehicle is accelerated or decelerated, wherein the multi-stage spring can urge the idler wheel in a second manner when debris is caught between the track and a wheel on the vehicle, and wherein the multi-stage spring can urge the idler wheel in a third manner when the suspension of the vehicle is compressed.

In a fourth aspect, the invention is directed to a track tensioner for maintaining a selected tension in a track on a tracked vehicle, comprising a multi-stage spring that can bias the idler wheel in a first manner when the vehicle is accelerated or decelerated, wherein the multi-stage spring can bias the idler wheel in a second manner when debris is caught between the track and a wheel on the vehicle.

### BRIEF DESCRIPTION OF THE DRAWINGS

The present invention will now be described by way of example only, with reference to the attached drawings in which:

FIG. 1 is a side view of a tracked vehicle with a multi-stage spring in accordance with a first embodiment of the present invention;

FIG. 1a is a magnified side view of a portion of the tracked vehicle shown in FIG. 1;

FIG. 2a is a side view illustrating compression of the suspension of the tracked vehicle shown in FIG. 1;

FIG. 2b is a side view illustrating acceleration of the tracked vehicle shown in FIG. 1;

FIG. 2c is a side view illustrating debris being caught between the track and a wheel of the tracked vehicle shown in FIG. 1;

FIG. 3 is a graph illustrating the relationship between compressive force and position for the multi-stage spring shown in FIG. 1;

FIGS. 4a, 4b, 4c and 4d are magnified sectional side views of the multi-stage spring shown in FIG. 1, in several positions;

FIG. 4e is a magnified sectional side view of the multi-stage spring shown in the position shown in FIG. 4b;

FIG. 5 is a sectional side view of a multi-stage spring in accordance with another embodiment of the present invention;

FIG. 6 is a sectional side view of a multi-stage spring in accordance with another embodiment of the present invention;

FIG. 7 is a sectional side view of a multi-stage spring in accordance with another embodiment of the present invention;

FIG. 8 is a graph illustrating the relationship between compressive force and position for the multi-stage spring shown in FIG. 7;

FIGS. 9a, 9b and 9c are sectional side views of a multi-stage spring shown in accordance with another embodiment of the present invention, shown in several positions;

FIGS. 10a, 10b and 10c are sectional side views of a multi-stage spring shown in accordance with another embodiment of the present invention, shown in several positions;

FIG. 11 is a sectional side view of a multi-stage spring in accordance with another embodiment of the present invention; and

FIGS. 12a and 12b are sectional side views of a multi-stage spring shown in accordance with another embodiment of the present invention; shown in several positions.

### DETAILED DESCRIPTION OF THE INVENTION

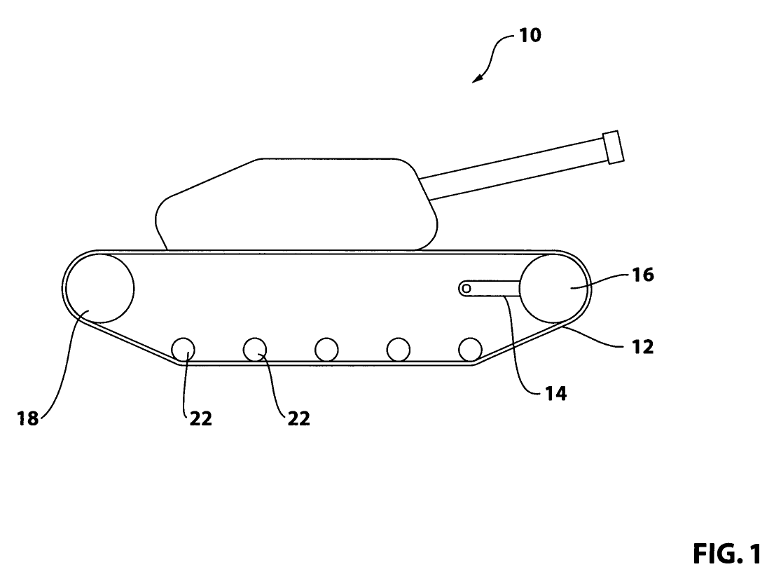

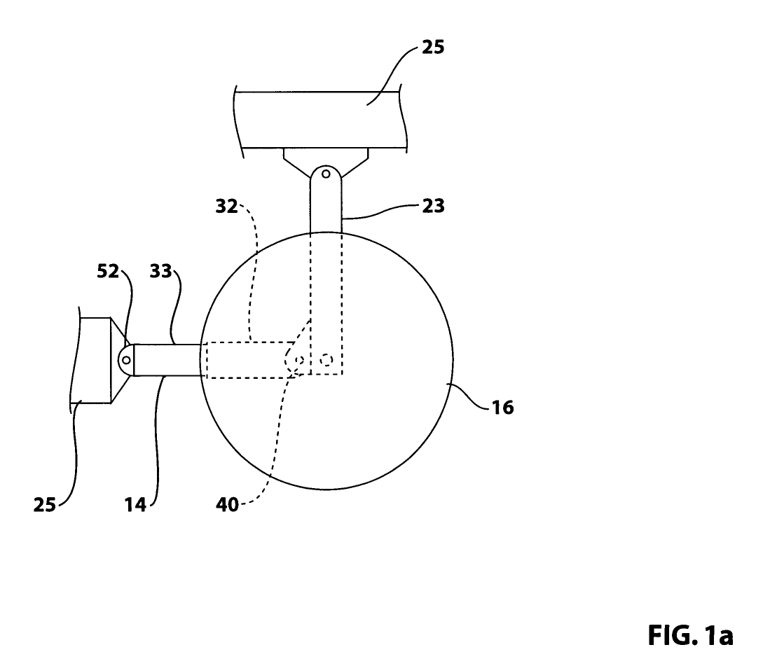

Reference is made to FIG. 1, which shows vehicle 10 with a pair of tracks 12. Each track 12 has associated therewith, a drive wheel 18, an idler wheel 16 and a plurality of road wheels 22. A suspension (not shown) permits the road wheels 22 to rise and lower in response to the features of the terrain over which the vehicle 10 is driving.

The drive wheel 18 is shown in FIG. 1 as being at the rear of the vehicle 10, and the idler wheel 16 is shown as being at the front. It is, however, alternatively possible for the drive wheel 18 to be at the front and for the idler wheel 16 to be at the rear.

The path of the track about the wheels 22, 16 and 18 has an effective path length associated therewith. The associated effective track path length may change constantly during use of the vehicle 10 as the vehicle suspension compresses, or extends.

The vehicle 10 includes a multi-stage spring 14, in accordance with a first embodiment of the present invention, which may be used as a device for inhibiting the track 12 from detracking from the wheels 22, 16 and 18, and from being damaged as a result of overtensioning during use of the vehicle 10. The multi-stage spring 14 assists the vehicle 10 in accommodating changes in effective track path length, and in accommodating changes in the track tension.

During use, the track 12 is generally kept under some tension, which assists the track 12 in staying in contact with the wheels 22, 16 and 18. The tension in the track 12 is exerted as a compressive force on the multi-stage spring 14. It will be noted that, during use, the tension in the upper section of track 12 (ie. the section of track 12 between the tops of the drive and idler wheels 18 and 16) may be different than the tension in the lower section of the track, (ie. the section of track 12 that extends between the bottoms under the drive and idler wheels 18 and 16) at any given time. The tensions in both the upper and lower sections of the track 12 influence the compressive force that is exerted on the multi-stage spring 14.

Reference is made to FIG. 1a. The idler wheel 16 may be rotatably connected to an idler wheel support 23 which permits the idler wheel 16 to be movable relative to the body of the vehicle 10, and more particularly, to be movable to change its distance from the drive wheel 18 (FIG. 1). For example, the idler wheel support 23 may be pivotably connected at its upper end to the vehicle frame, shown at 25, and the idler wheel support 23 may have at its lower end the idler wheel 16 connected thereto. The multi-stage spring 14 is connected between the idler wheel support 23 and the vehicle frame 25.

Alternatively to the structure described above, the spring 14 may be connected to any suitable structure for moving the idler wheel 16 in relation to the drive wheel 18. For example, the structure may include a cantilevered beam that is slidable relative to the vehicle body instead of a pendulum-type construction shown in FIG. 1a.

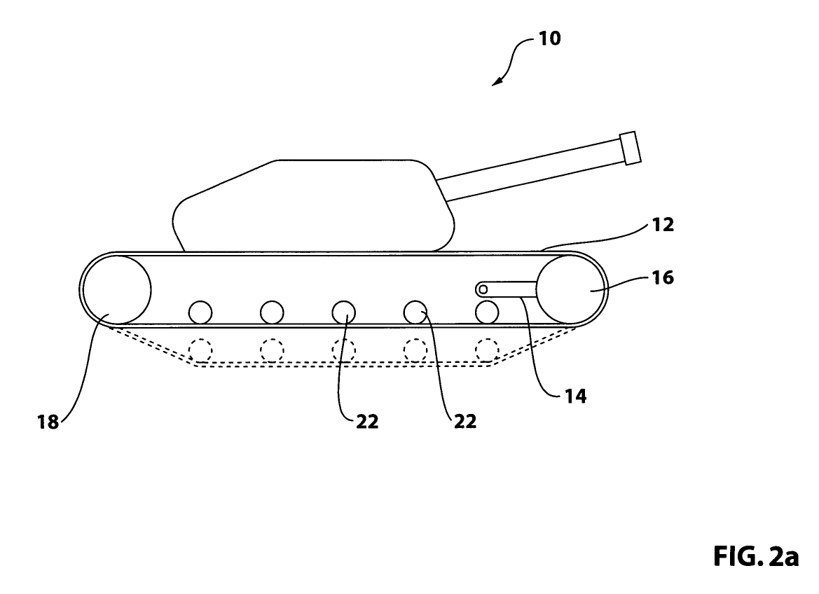

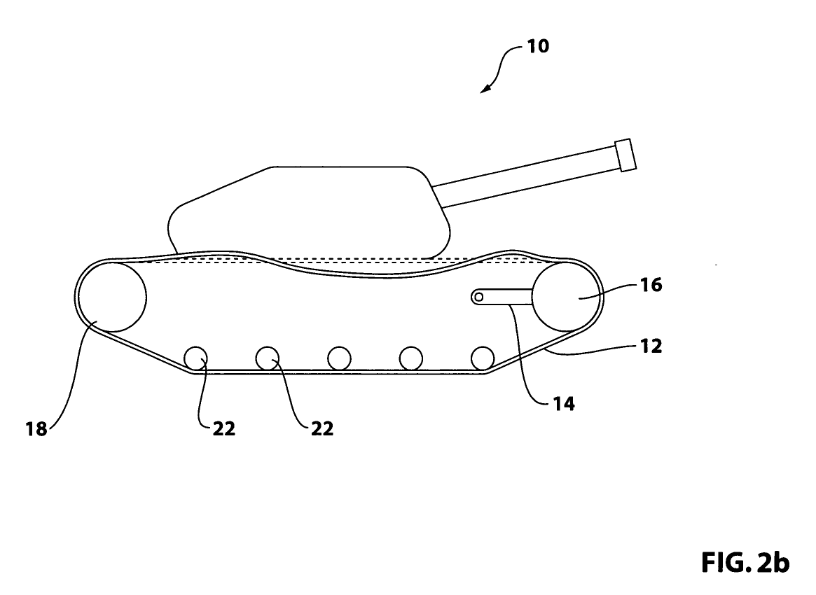

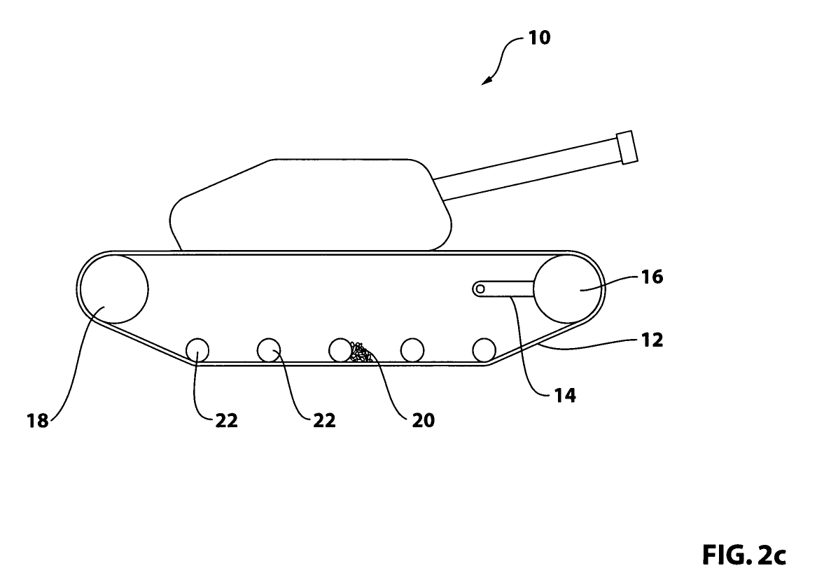

Referring to FIGS. 2a, 2b and 2c, the multi-stage spring 14 may be configured to provide a selected tension in the track 12 in several situations that can occur during use of the tracked vehicle 10. For example, the multi-stage spring 14 may be configured to reduce the risk of detracking when the vehicle 10 suspension compresses, thereby raising the road wheels 22 relative to the body of the vehicle 10, as shown in FIG. 2a. As another example, the multi-stage spring 14 may be configured to reduce the risk of detracking or of damaging the track 12 and associated components during acceleration as shown in FIG. 2b. As another example, the multi-stage spring 14 may be configured to reduce the risk of detracking or of damaging the track 12 and associated components during deceleration. As yet another example, the multi-stage spring 14 may be configured to reduce the risk of damaging the track 12 in the event that a piece of debris 20 becomes lodged between the track 12 and one of the wheels 16, 18 or 22, as shown in FIG. 2c. By maintaining a selected amount of tension in all of these situations, the multi-stage spring 14 increases the range of conditions in which the vehicle 10 can operate without being stopped as a result of a problem with the track 12, relative to vehicles with certain tensioning systems of the prior art. Additionally, the multi-stage spring 14 achieves the above in a relatively compact package, which can facilitate fitting it into the available space in the vehicle 10.

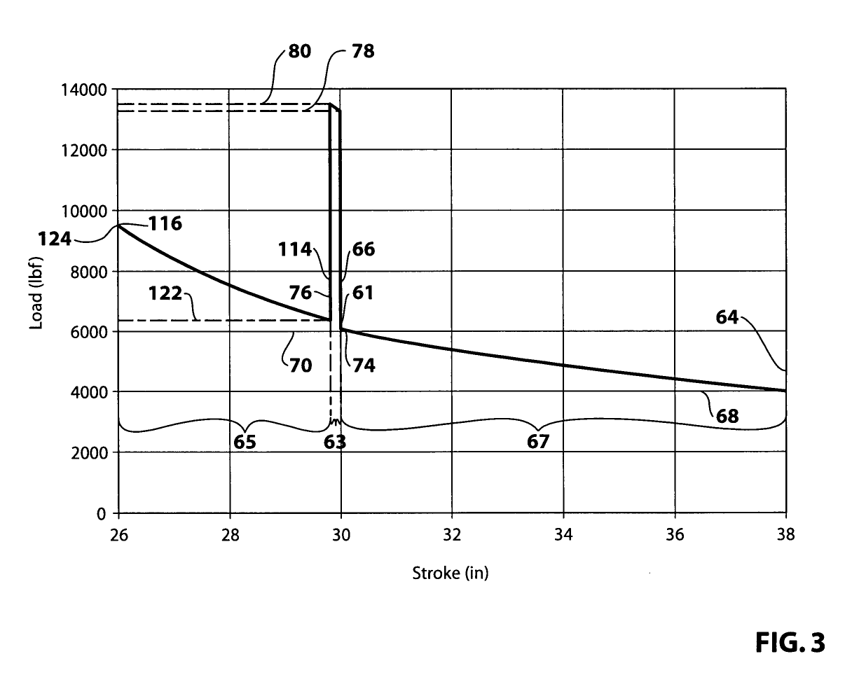

FIG. 3 illustrates the features of the compression/force relationship for the spring 14 (FIG. 1). When installed in the vehicle 10 (FIG. 1), the spring 14 (FIG. 1) may have a home position 61 in which it is in a state of compression. The spring 14 (FIG. 1) includes a first response zone 63 (FIG. 3), a second response zone 65 (FIG. 3), and optionally, a third response zone 67 (FIG. 3).

The first response zone 63 (FIG. 3) corresponds to a first range of positions for the spring 14 (FIG. 1), in which the spring 14 has a first force/position relationship. The first response zone 63 (FIG. 3) extends between a first range initial position 74 and a first range final position 76. The response of the spring 14 (FIG. 1) as the spring 14 moves from the first range initial position 74 (FIG. 3) towards the first range final position 76 is different than the response of the spring 14 (FIG. 1) as the spring 14 moves from the first range final position 76 (FIG. 3) towards the first range initial position 74. During compression of the spring 14 (FIG. 1), in the first response zone 63 (FIG. 3) a compressive force exerted on the spring 14 (FIG. 1) below a first range initial force 78 (FIG. 3) generates no movement in the spring 14 (FIG. 1). Thus, the spring 14 remains in the first range initial position 74 (FIG. 3). If the compressive force on the spring 14 (FIG. 1) is greater than the first range initial force 78 (FIG. 3), some compression of the spring 14 (FIG. 1) takes place towards the first range final position 76 (FIG. 3).

The first response zone 63 may be selected to extend over a relatively short range of travel for the spring 14 (FIG. 1). For example, for the embodiment illustrated in FIG. 3, the first response zone 63 may extend over about 6 mm (¼″) or over about 13 mm (½″) of travel of the spring 14.

The second response zone 65 corresponds to a second range of positions for the spring 14 (FIG. 1), in which the spring 14 has a second force/position relationship that is different from the first force/position relationship that exists in the first response zone 63 (FIG. 3). The second response zone 65 extends between a second range initial position 114 and a second range final position 116. The second range initial position 114 corresponds to the first range final position 76.

In the second response zone 65 (FIG. 3), the spring 14 (FIG. 1) may have a generally linear relationship between the compressive force exerted thereon by the track 12 and the spring position. As the compressive force increases, the spring 14 compresses, moving towards the second range final position 116 (FIG. 3).

A second range initial force 122 is required to initiate movement of the spring 14 (FIG. 1) away from the second range initial position 114 (FIG. 3) in the second response zone 65.

A second range final force 124 is required to bring the spring 14 (FIG. 1) to the second range final position 116 (FIG. 3). In the embodiment shown, the second range final position 116 corresponds to the compressed position for the spring 14 (FIG. 1). Thus, any compressive force that is greater than the second range final force 124 (FIG. 3), while the spring 14 (FIG. 1) is in the second response zone 65 (FIG. 3) will cause the spring 14 (FIG. 1) to move to the second range final position 116 (FIG. 3).

The third response zone 67 corresponds to a third range of positions for the spring 14 (FIG. 1), in which the spring 14 has a third force/position relationship that is different from the first force/position relationship that exists in the first response zone 63 (FIG. 3). The third response zone 67 extends between a third range initial position 64 and a third range final position 66. The third range initial position 64 corresponds to the extended position for the spring 14 (FIG. 1), which is the rest position for the spring 14.

In the third response zone 67 (FIG. 3), the spring 14 (FIG. 1) may have a generally linear relationship between the compressive force exerted thereon by the track 12 and the spring position. As the compressive force exerted on the spring 14 increases, the spring 14 compresses, moving towards the third range final position 66 (FIG. 3). As the compressive force decreases, the spring 14 (FIG. 1) extends, moving towards the third range initial position 64 (FIG. 3).

The average spring rate for the spring 14 (FIG. 1) in the third response zone 67 (FIG. 3) may be similar to the average spring rate for the spring 14 (FIG. 1) in the second response zone 65 (FIG. 3).

A third range initial force 68 initiates movement of the spring 14 (FIG. 1) away from the third range initial position 64 (FIG. 3). It is possible for this minimum force to be selected to be any suitable value, such as 17800 N (4000 lbf), as shown in FIG. 3.

A third range final force 70 brings the spring 14 (FIG. 1) to the third range final position 66 (FIG. 3). In the embodiment shown in FIG. 3, the third range final position 66 corresponds to the first range initial position 74 for the spring 14 (FIG. 1) in the first response zone 63. It is possible for this third range final force 70 to be selected to be any suitable value, such as 26700 N (6000 lbf), as shown in FIG. 3.

In embodiments wherein the average spring rates for the second and third response zones 65 and 67 are similar, and if the third range final force 70 is a selected amount less than the second range initial force 122 for the second response zone 65, then the second and third response zones 65 and 67 may be substantially collinear in the graph shown in FIG. 3. In this way, as the spring 14 (FIG. 1) extends from a position within the second response zone 65 (FIG. 3) to a position within the third response zone 67, the movement of the spring 14 (FIG. 1) is substantially continuous and substantially linear throughout extension of the spring 14 from a position in the third response zone 67 (FIG. 3).

By providing the spring 14 (FIG. 1) with the force/position relationships of the first, second and third response zones 63, 65 and 67 (FIG. 3), the spring 14 (FIG. 1) permits the vehicle 10 to undergo acceleration/deceleration, to incur debris 20 between the track 12 and one or more of the wheels 22, 16, or 18, and to incur maximum compression of some portion or all of the suspension, all with a reduced risk of detracking and damage to the track 12.

The home position 61 (FIG. 3) of the spring 14 (FIG. 1) is the position of the spring 14 when the vehicle 10 is at rest. The home position 61 (FIG. 3) may be selected to be anywhere suitable, such as at the first range initial position 74 or somewhere in the third response zone 67 near the third range final position 66. An exemplary home position 61 of the spring 14 (FIG. 1) at the initial position 74 (FIG. 3) for the first response zone 63 is used below for the purpose of illustrating the operation of the spring 14 in the situations described with reference to FIGS. 2a, 2b and 2c. Also for example purposes, the initial tension in the track 12 is selected to be 29000 N (6500 lbf).

If, when the spring 14 is in the home position 61 (FIG. 3), the track tension increases resulting in an increase in the compressive force on the spring 14 (FIG. 1), then the spring 14 (FIG. 1) remains in the home position 61 (FIG. 3), if the overall compressive force remains below the first range initial force 78 (FIG. 3). By having the spring 14 (FIG. 1) remain at the first range initial position 74 (FIG. 3) during this increase in compressive force, the track 12 (FIG. 1) is less likely to detrack from the idler wheel 16 than if the tensioner were permitted to compress. If the tension in the track 12 increases to a level wherein the compressive force on the spring 14 is greater than the force 78 (FIG. 3), then movement of the spring 14 (FIG. 1) is initiated. If the compressive force on the spring 14 is greater than the force 80 (FIG. 3), then the spring 14 (FIG. 1) moves into the second response zone 65 (FIG. 3), wherein it compresses in response to a force that is lower than the first range final force 80 and wherein the spring compression increases substantially linearly with force. By providing the second response zone, wherein the spring 14 (FIG. 1) is permitted to compress with the application of a reduced force, the compression of the spring 14 reduces the overall path length for the track and in turn reduces the tension in the track 12. Thus, the spring 14 limits the maximum tension that is incurred by the track 12 to the force 80. In this way, the spring 14 protects the track 12 against overtensioning.

If, when the spring 14 is in the home position 61 (FIG. 3), the overall compressive force on the spring 14 (FIG. 1) decreases, then the spring 14 extends from its home position 61 (FIG. 3) into the third response zone 67. In the third response zone 67, the spring 14 (FIG. 1) extends outwards to maintain some biasing force on the idler wheel 16, thereby maintaining some level of tension in the track 12 to inhibit the track 12 from skipping on a wheel 16 or 18, and reducing the risk of detracking of the track 12.

The extended position of the spring 14 (FIG. 1) may be selected to maintain a minimum selected level of tension in the track 12 in the situation where the vehicle suspension is entirely bottomed out. The extended length of the spring 14 (FIG. 1) may be any selected length, such as, for example, 965 mm (38″).

Without being limited by theory, some examples of conditions in which the track tension varies are discussed with reference to FIGS. 2a, 2b, 2c and 3. Reference is made to FIG. 2a and FIG. 3. In the event that the vehicle 10 (FIG. 2a) encounters conditions that cause some or all of the suspension to compress, the road wheels 22 are moved upwards relative to the body of the vehicle 10. This relative movement between the road wheels 22 and vehicle body causes a reduction in the overall path length for the track 12 and consequently a reduction in the amount of tension in the track 12. In order to maintain some tension in the track 12, the reduction in track tension causes the spring 14 to extend from its home position 61 (FIG. 3) into the third response zone 67. In the third response zone 67, the spring 14 (FIG. 2a) extends outwards to maintain some biasing force on the idler wheel 16 thereby maintaining some level of tension in the track. Thus, compression or even bottoming out of the suspension of the vehicle 10 has a reduced level of risk of causing detracking of the track 12 from the idler wheel 16 and/or the drive wheel 18. When the suspension returns to its neutral position, the tension in the track 12 is restored to its selected value and the spring 14 is compressed to its home position 61 (FIG. 3).

Reference is made to FIG. 2b and FIG. 3. During acceleration, the torque from the drive wheel 18 (FIG. 2a) causes a portion of the track 12 to undergo an increase in tension, while another portion of the track 12 undergoes a decrease in tension. For example, if the drive wheel 18 is at the rear of the vehicle 10, then the portion of track 12 between the drive wheel 18 and the nearest ground wheel 22 may increase in tension, and the top section of the track 12 between the drive and idler wheels 18 and 16 undergoes a decrease in tension. Additionally, the vehicle 10 may have a tendency to squat down on its suspension during hard acceleration, which will reduce the tension in the track 12 overall, as explained above with reference to FIG. 2a.

As a result of the reduced tension, the spring 14 (FIG. 1) will move into the third response zone 67 (FIG. 3), as described above. Once the suspension returns to its neutral position and the rate of acceleration decreases sufficiently, the spring 14 (FIG. 1) will return to its home position 61 (FIG. 3).

During deceleration, braking force is applied to the drive wheel 18 (FIG. 2b). The braking force causes the bottom section of the track 12 to undergo an increase in tension. Additionally, the tension in the top section of track 12 may also undergo an increase in tension towards the front of the vehicle, ie. about the idler wheel 16. The tension at the rear of the vehicle 10 about the drive wheel 18 in particular may be reduced. The increased tension in the track 12 near the front will result in an increase in the overall compressive force on the spring 14, in which case the spring 14 remains in the first range initial position 74 shown in FIG. 3, if the compressive force on the spring 14 (FIG. 2b) remains below the first range initial force 78 (FIG. 3), then the spring 14 (FIG. 2b) remains at the first range initial position 74 (FIG. 3). By having the spring 14 (FIG. 2b) remain at the first range initial position 74 (FIG. 3) during this increase in compressive force, the track 12 (FIG. 2b) is less likely to detrack from one or both of the wheels 16.

After deceleration has been completed, the spring 14 may return to its home position 61 as shown in FIG. 3.

The first range initial force 78 is selected to be sufficiently high so as to be above the maximum force that can be exerted on the spring 14 (FIG. 2b) as a result of acceleration or deceleration. In this way, acceleration or deceleration will not move the idler wheel 16 any closer than a selected distance from the drive wheel 18, and will thus reduce the risk of detracking of the track 12.

It is optionally possible to select the first range final force 80 (FIG. 3) to be sufficiently high so as to be above the maximum force exerted on the spring 14 (FIG. 2b) from acceleration and deceleration instead of selecting the first range initial force 78 (FIG. 3) for that purpose.

Reference is made to FIG. 2c and FIG. 3. In the event that debris 20 (FIG. 2c) becomes stuck between the track 12 and a wheel 22, 16 or 18, the motion of the vehicle 10 in combination with the torque of the vehicle engine (not shown) can urge the vehicle 10 towards passing the debris 20 between the wheel 22, 18 or 16 and the track 12. As the debris 20 begins to pass between the track 12 and the wheel 22, 18 or 16, the tension in the track 12 increases.

The maximum force required to move the spring 14 in the first response zone 63 (FIG. 3), may be, for example, the first range final force 80. This first maximum force is selected to be below the force that would cause tensile damage to the track 12 (FIG. 2c). In other words, at the tensile breaking point of the track 12, the compressive force generated by tension in the track 12 would be beyond the first range final force 80 (FIG. 3).

If the track tension increases beyond the first range final force 80, then the spring 14 (FIG. 2c) moves into the second response zone 65 (FIG. 3). In the second response zone 65, the force required to move the spring 14 (FIG. 2c) is reduced relative to the forces required in the first response zone 63 (FIG. 3). Throughout the second response zone, the force required to move the spring 14 (FIG. 2c) does not exceed the maximum force for the first response zone. Put another way, the second maximum force, which is the maximum force that is associated with a position in the second response zone 65 (FIG. 3), is less than the first maximum force. Thus, the force required to move the spring 14 (FIG. 2c) never exceeds the first maximum force, throughout the first and second response zones.

By providing this feature, the tension incurred by the track 12 is controlled to be below a selected value (the breaking force for the track 12) during use of the vehicle 10.

As a result of the spring 14 reducing its resistance to a compressive force by moving into the second response zone 65 (FIG. 3), the tension in the track 14 (FIG. 2c) is kept below the tension that would be required to cause damage to the track 12. This reduction in track tension facilitates the passage of the debris 20 between the track 12 and the wheel 22, 16 or 18, by facilitating the spacing of the track 12 from the wheel 22, 18, 16 where the debris 20 is being passed.

The second response zone 65 of the spring 14 may provide any selected amount of travel. For example, the second response zone 65 (FIG. 3) may provide about 100 mm (4″) of travel for the spring 14 (FIG. 2c), which permits debris 20 of a maximum selected size to pass between the track 12 and a wheel 22, 16 or 18. After the debris 20 has passed between the track 12 and a wheel 22, 16 or 18, the tension in the track reduces and the spring 14 may return to its home position 61.

If the debris 20 is larger than the maximum size that can be accommodated by the spring 14, then the spring 14 may travel to its compressed position, at which point the track tension may increase up to any value based on the physical parameters of the situation. If the track tension increases beyond a critical value, then the track 12 can incur damage. If the track tension does not increase beyond the critical value, it may reach a value that is nonetheless sufficiently high to destroy the debris 20. Alternatively, it may not reach a value that is sufficiently high to destroy the debris 20, and the movement of the track 12 may be stopped by the inability to pass the debris 20 or to destroy the debris 20.

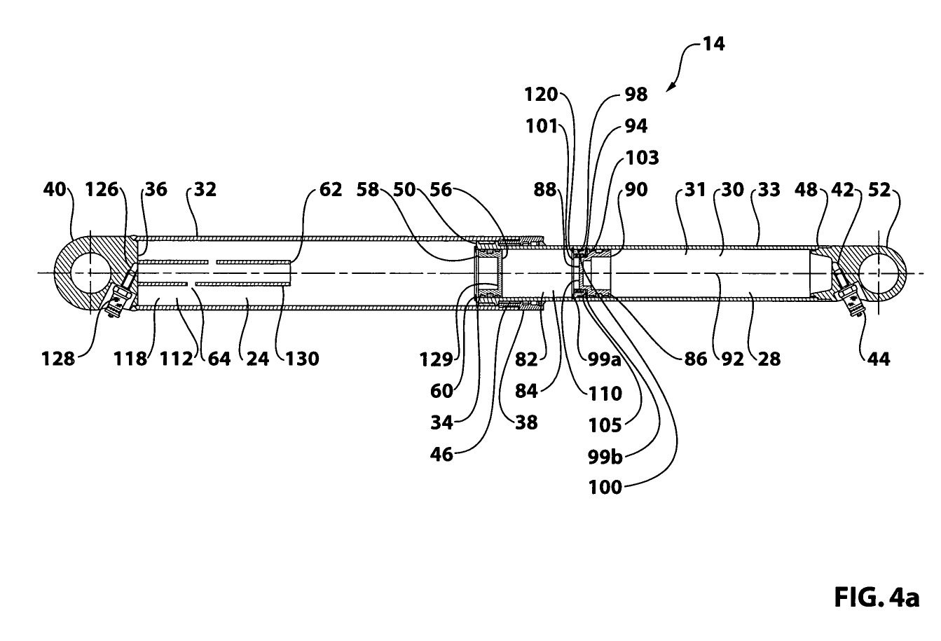

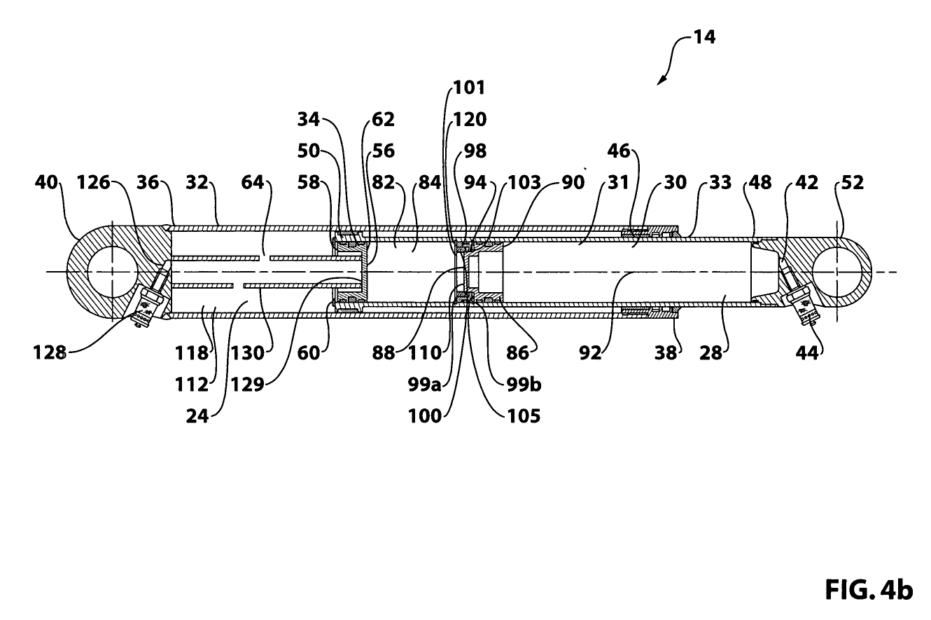

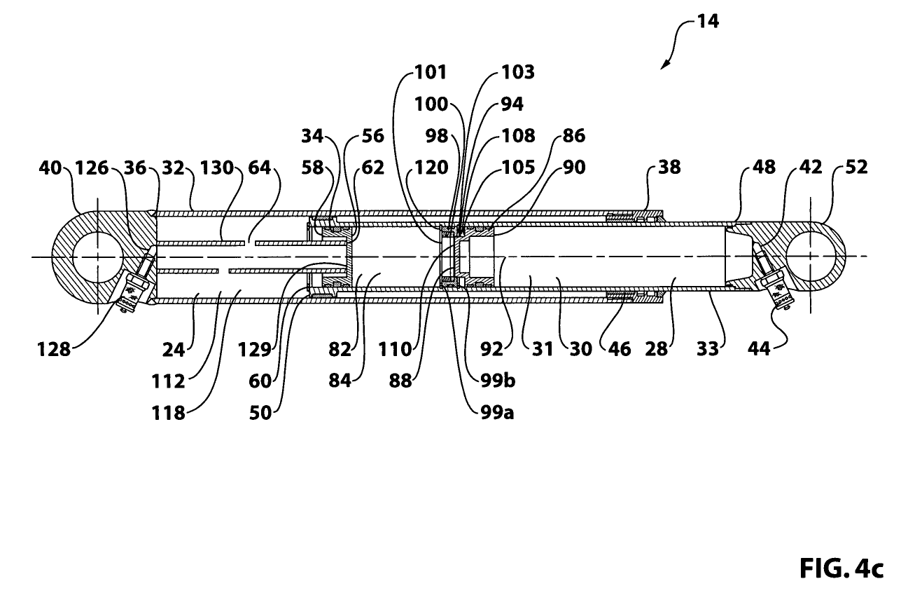

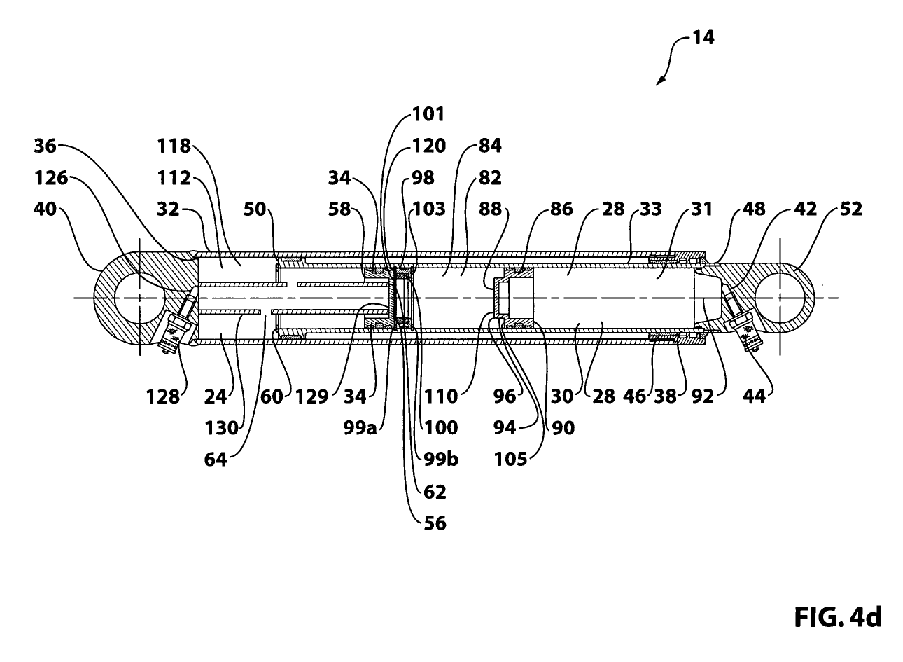

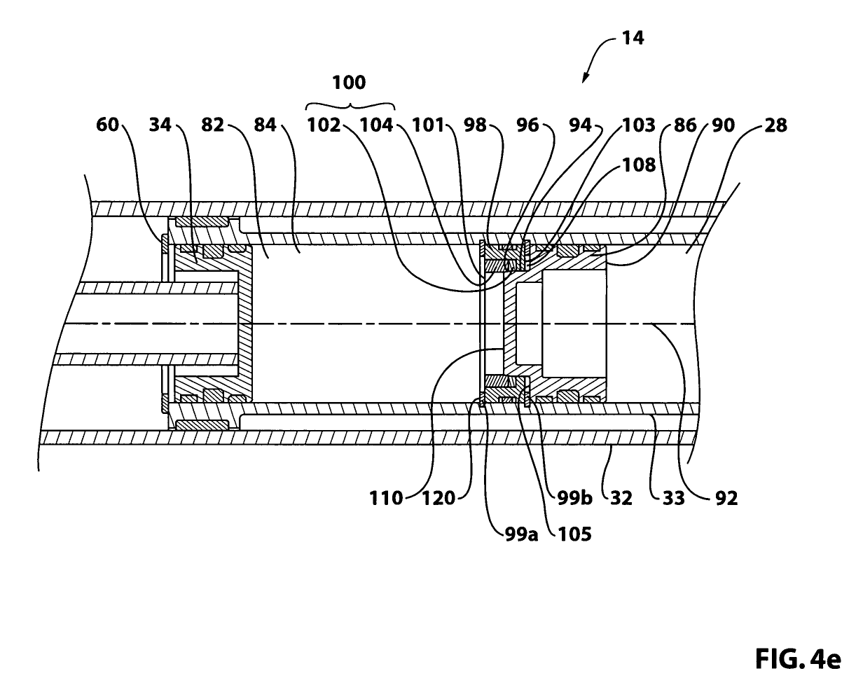

Reference is made to FIGS. 4a-4d, which illustrate the spring 14 in several positions. The extended position of the spring 14, ie. the third range initial position 64 (FIG. 3), is shown in FIG. 4a. The third range final position 66 (FIG. 3), which is also the first range initial position 74 for the first response zone 63, is shown in FIG. 4b. The first range final position 76, which is also the second range initial position 114 (FIG. 3), is shown in FIG. 4c. The second range final position 116 (FIG. 3), which is the collapsed position for the spring 14, is shown in FIG. 4d. The home position 61, as identified in FIG. 3, corresponds to the position of the spring 14 shown in FIG. 4b.

Referring to FIGS. 4a-4d, the spring 14 includes a first piston housing 33, a first piston 86, a second piston 34, a first biasing means 28 and a second biasing means 24. The first and second pistons 86 and 34 are movable within the first piston housing 33. A piston-to-piston chamber 82 is defined between the first and second pistons 86 and 34. A first-and-second-piston force transfer fluid 84 is contained in the piston-to-piston chamber 82. The first-and-second-piston force transfer fluid 84 is preferably a substantially incompressible fluid, such as, for example, a liquid.

The first piston housing 33 has a first end 48 and a second end 50. The first end 48 is closed and constitutes the first end of the spring 14. A first connector 52, which may be any suitable structure, such as, for example, a mounting ear, may be positioned at the first end 48 of the first piston housing 33.

The first piston 86 and, optionally the second piston 34, are slidable within the first piston housing 33 and seal with the first piston housing 33 against fluid leakage therepast throughout their movement. The first piston 86 and the second piston 34 move together in the housing 33, while defining the piston-to-piston chamber 82 between them. The first piston 86 has a first side 88 and a second side 90. The first side 88 faces the piston-to-piston chamber 82 and is thus a chamber-facing side. The second side 90 faces the first biasing means 28.

Each side 88 and 90 of the piston 86 has a cross-sectional area A which is the area of the piston in a plane that is perpendicular to the housing axis, shown at 92. The cross-sectional area A represents the total effective cross-sectional area on the chamber-facing side 88 of the piston 86 which would be responsive to the influence of the first-and-second-piston force transfer fluid 84 in urging the piston 86 to move.

Referring to FIG. 4e, the first side 88 of the piston 86 is stepped and has a first selected surface portion 105 that extends radially, a seal surface 94 that extends generally in an axial direction and a second selected surface portion 110 that extends radially. Extending ‘radially’ is not limited to extending only in a radial plane. Extending ‘radially’ means extending in any direction that is not axial, so that if a surface extends radially, even slightly, the surface would be urged in an axial direction by fluid pressure against the surface. The axial direction is a direction that is parallel to the direction of movement of the first piston 86.

Referring to FIG. 4d, the seal surface 94 includes an optional lead-in surface 96, which tapers slightly in a direction away from the piston 86. The effective cross-sectional area of the second portion 110 is less than the effective cross-sectional area A on the second side 90 of the piston 86. Optionally, the effective cross-sectional area of the second portion 110 is about ⅓ of the effective cross-sectional area A that may be present on the second side 90 of the piston 86.

The first piston housing 33 includes a seat member 98 that receives the stepped piston 86. More particularly, the seat member 98 includes a sealing portion 100, which is configured to form a seal with the seal surface 94 of the stepped piston 86. The sealing portion 100 may include a plurality of individual seal members, such as members 102 and 104.

The seat member 98 may mount in the housing 33 in any suitable way. For example, the seat member 98 may mount to the housing 33 using a first snap ring 99a and a second snap ring 99b. The seat member 98 has a first side 101 and a second side 103, each of which extends in a radial plane.

A space 108 is the volume defined between the first surface portion 105 on the piston 86 and the second side 103 on the seat member 98. The space 108 is also further defined by the seal surface 94 on the piston 86. In the embodiment shown in FIGS. 4a-4e, the space 108 is further defined by the snap ring 99b.

When the first surface portion 105 of the piston 86 engages the second side 103 of the seat member 98, at which point the piston 86 is fully seated in the seat member 98, as shown in FIGS. 4a and 4b, the second portion 110 on the first side 88 of the piston 86 is exposed to the pressure of the first-and-second-piston force transfer fluid 84 in the piston-to-piston chamber 82.

The second piston 34 has a first side 56 and a second side 58. The first side 56 faces the piston-to-piston chamber 82 and is thus a chamber-facing side. The second side 58 faces the first biasing means 28.

A stop member 60 is positioned on the first piston housing 33 to prevent the inadvertent release of the second piston 34 from the second end 50 of the first piston housing 33 during movement of the spring 14 and particularly during movement of the spring 14.

A limit surface 120 is provided on the housing 33, to set the maximum travel of the second piston 34 in the housing 33. The limit surface 120 may, for example, be provided on the seat member 98 and may correspond to a surface of the snap ring 99a on the first side 101 of the seat member 98.

The first biasing means 28 urges the first piston 86 away from the first end of the spring 14, which is the first end 48 of the first piston housing 33, and towards the seat member 98. The first biasing means 28 urges the first piston 86 to seat in the seat member 98. The first biasing means 28 may have any suitable structure for urging the piston 86. In the embodiment shown in FIG. 4a-4d, the first biasing means 28 includes a first biasing means fluid chamber 30, which contains a first biasing means fluid 31, which may be a compressible fluid, such as, for example, a gas, and more particularly Nitrogen. The first biasing means fluid chamber 30 is defined by the housing 33 and the piston 86, and more particularly, by the housing 33 and the second side 90 of the piston 86.

A port 42 may be provided at the first end 48 to permit the first biasing means fluid chamber 30 to be filled with the first biasing means fluid 31. A plug 44 is removably connected to the first end 48 to close the port 42.

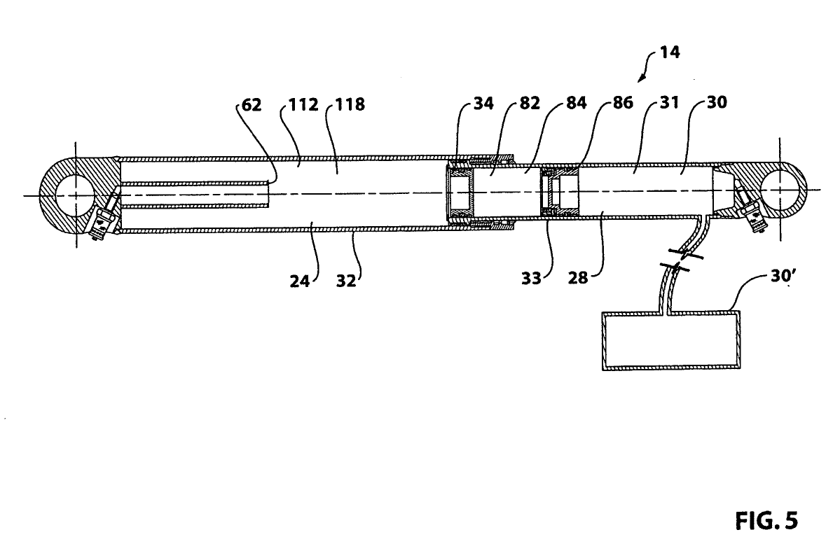

As an alternative, the first biasing means fluid chamber 30 could be made smaller than that shown in FIGS. 4a-4d, and the first biasing means fluid chamber 30 could be connected to a remote chamber 30′ by a first biasing means fluid conduit 35, as shown in FIG. 5. Such an alternative would reduce the overall length of the spring 14, thus permitting it to be installed on a vehicle 10 with less available space. As another alternative, the first biasing means 28 may include some other structure instead of a fluid chamber, such as a mechanical compression spring, or a resiliently compressible natural or synthetic polymeric material such as a foam rubber.

The spring 14 includes an optional sleeve 32, in which the housing 33 slides. The sleeve 32 is generally tubular and has a first, closed end 36 and a second end 38. The first end 36 constitutes a second end of the spring 14. A second connector 40, which may be any suitable structure, such as, for example, a mounting ear, may be positioned at the first end 36 of the sleeve 32. The connectors 40 and 52 are used to mount the spring 14 between suitable components of the vehicle 10, such as, for example, between the idler wheel support 23 and the vehicle frame 25 as shown in FIG. 1a.

The second biasing means 24 urges the second piston 34 away from the second end of the spring 14, which is the first end 36 of the sleeve 32, and urges the first piston housing 33 away from the second end of the spring 14.

The biasing means 24 may have any suitable structure for urging the second piston 34. In the embodiment shown in FIG. 4a-4d, the second biasing means 24 includes a second biasing means fluid chamber 112, which contains a second biasing means fluid 118, which may be a compressible fluid, such as, for example, a gas, and more particularly Nitrogen. The second biasing means fluid chamber 112 is defined by the sleeve 32, the housing 33 and the second piston 34, and more particularly, by the sleeve 32, the housing 33 and the second side 58 of the second piston 34.

A port 126 may be provided at the first end 36 of the sleeve 32 to permit the second biasing means fluid chamber 112 to be filled with the second biasing means fluid 118. A plug 128 is removably connected to the first end 36 to close the port 126.

In embodiments wherein the second biasing means fluid chamber 112 is provided in the sleeve 32, a seal member 46 is provided between the housing 33 and sleeve 32 which permits sliding motion between the two, while maintaining a seal therebetween to prevent leakage of the fluid 118.

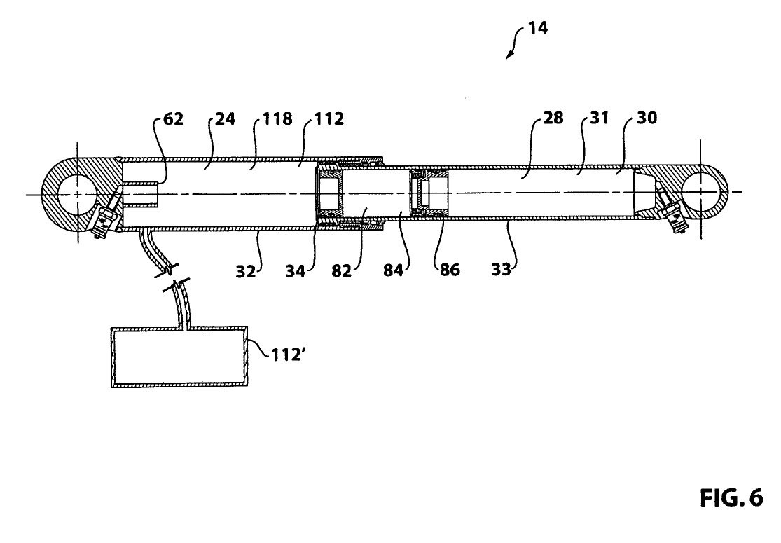

As an alternative, the second biasing means fluid chamber 112 could be made smaller than that shown in FIGS. 4a-4d, and the second compressible chamber 112 could be connected to a remote chamber 112′ by a second biasing means fluid conduit 113, as shown in FIG. 6. Such an alternative would reduce the overall length of the spring 14, thus permitting it to be installed on a vehicle 10 with less available space. As another alternative, the second biasing means 24 may include some other structure instead of a fluid chamber, such as a mechanical compression spring.

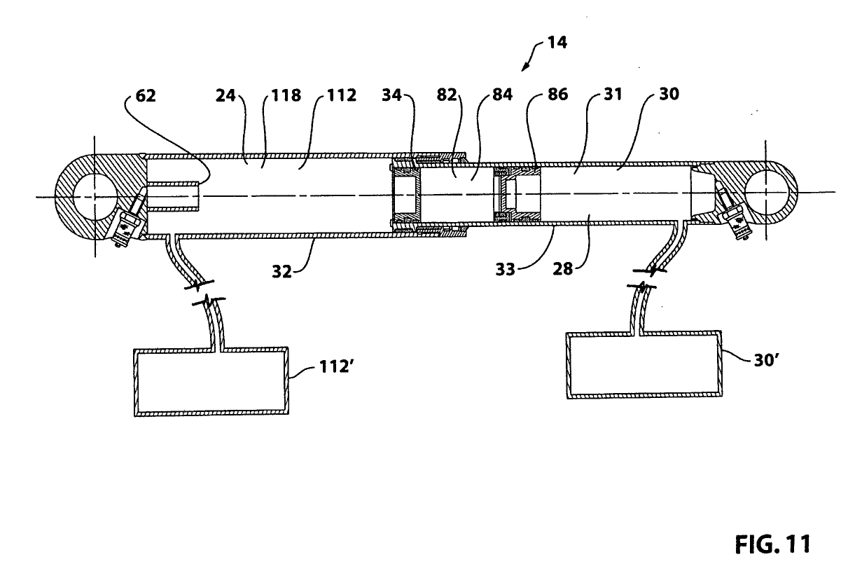

As a further alternative, the spring 14 may include both remote reservoirs 30′ and 112′ (FIG. 11) connected respectively to the first and second biasing means fluid chambers 30 and 112, to further shorten the overall length of the spring 14.

A piston engagement surface 62 and a sleeve engagement surface 129 are provided on the sleeve 32 and second piston 34 respectively and engage each other at a selected position of the spring 14 to urge the second piston 34 to move relative to the housing 33. The piston engagement surface 62 may be provided on a hollow tube 130, as shown in FIGS. 4a-4d. The hollow tube 130 may be provided with fluid communication apertures 64 permitting communication of the second biasing means fluid 118 between the outside and the inside of the tube 130 which ensures that fluid pressure remains equal inside and outside the tube 130 when the tube 130 abuts the second piston 34. Alternatively, the piston engagement surface 62 may be provided on some other suitable structure such as on a solid rod, which would not require fluid communication apertures 64. The sleeve engagement surface 129 on the second piston 34 may simply be a portion of the surface on the second side 58.

Instead of providing the hollow tube 130 or other structure in the sleeve 32 for abutting the second piston 34, it is alternatively possible to provide a structure on the second side 58 of the second piston 34 to abut a portion of the interior surface of the sleeve 32.

When the spring 14 is installed in the vehicle 10 (FIG. 1), the tension in the tracks 12 may be selected such that the home position of the spring 14 is the home position 61 (FIG. 3), which corresponds to the position shown in FIG. 4b. This position corresponds to the first range initial position 74 (FIG. 3).

When installed on the vehicle 10 (FIG. 1), one of the ears 40 and 52 (FIG. 1a) may be connected to a fixed member, such as the vehicle frame 25, and the other of the ears 40 and 52 is connected to a movable member such as the idler wheel support 23. If the sleeve ear 40 is connected to the movable member, such as the idler wheel support 23 and the housing ear 52 is connected to the fixed member, such as the vehicle frame 25, as shown in FIG. 1a, then the following analysis is contemplated to apply.

In the first range initial position 74 (FIG. 3), the compressive force on the spring 14 (FIG. 1) that results from the tension in the tracks 12 urges the sleeve 32 (FIG. 4b) towards the housing 33. This in turn urges the second piston 34 in a direction towards the right in FIG. 4b. Additionally, the pressure from the fluid 118 in the second biasing means fluid chamber 112 also urges the second piston 34 in a direction towards the right, ie. towards the first piston 86. The second piston 34 transfers these forces to the fluid 84, which influences the pressure in the fluid 84. The fluid 84 exerts a force on the second portion 110 on the piston 86 in a direction towards the right. The biasing means 28, however, exerts a force in the direction towards the left on the piston 86. If the force on the second surface area 110 is less than the force from the biasing means 28, then the piston 86 will remain stationary and thus the spring 14 will not undergo any compression.

Referring to FIG. 1a, it will be understood that the housing ear 52 could alternatively be connected to the movable member, such as the idler wheel support 23 and the sleeve ear 40 could be connected to the fixed member, such as the vehicle frame 25.

For the purpose of illustrating the rest of the operation of the spring 14, the spring 14 will be assumed to have the housing ear 52 mounted to the vehicle frame 25 and to have the sleeve ear 40 mounted to the idler wheel support 23. It will, however, be appreciated that the spring 14 operates similarly even if it is reversed and has the housing ear 52 mounted to the idler wheel support 23 and has the sleeve ear 40 mounted tithe vehicle frame 25.

When the vehicle 10 (FIG. 1) accelerates or decelerates as shown in FIG. 2b, the compressive force on the spring 14 that results from the tension in the track 12 may increase. If the increased compressive force remains below the first range initial force 78 (FIG. 3), then the sleeve 32 (FIG. 4b) and housing 33 will remain stationary relative to each other and thus the spring 14 will remain in the position shown in FIG. 4b.

If the compressive force on the spring 14 increases beyond the first range initial force 78 (FIG. 3), then the force transferred through the fluid 84 (FIG. 4b) overcomes the force of the fluid 31 in the first biasing means fluid chamber 30. As a result, the piston 86 moves away from the first range initial position 74 (FIG. 3) in which it is fully seated, towards the first range final position 76 where it is nearly out of the seat 98, but where it remains sealed with the seat 98 to prevent the passage of fluid 84 into the space 108, which corresponds to the position shown in FIG. 4c. If the compressive force on the spring 14 increases beyond the first range final force 80, then the piston 86 leaves the seat 98 entirely.

At this point, the fluid 84 acts on both the first and second portions 105 and 110 on the first side 88 of the piston 86. This increases the force exerted on the first side 88 of the piston 86 for a given compressive force from the track tension. The increased cross-sectional area of the first side 88 of the piston 86 that incurs fluid pressure from the fluid 84, correspondingly reduces the compressive force necessary to be exerted on the spring 14 to produce the pressure necessary to overcome the fluid pressure from the first biasing means fluid 31. When the piston 86 first leaves the seat 98, the compressive force necessary to be exerted on the spring 14 to cause movement of the piston 86 against the pressure of the second biasing means fluid 118, corresponds to the first force 114 for the second response zone 65 (FIG. 3).

Any movement of the piston 86 (FIG. 4c) in this second response zone 65 (FIG. 3) causes the volume of the first biasing means fluid 31 (FIG. 4c) to be reduced, which increases the pressure of the fluid 31, according to the generally linear relationship shown in FIG. 3.

If the compressive force from the track tension increases sufficiently, the spring 14 (FIG. 4c) will move to the collapsed position shown in FIG. 4d, wherein the limit surface 120 abuts the second piston 34. At this point, any further increase in the compressive force from the track tension will not generate any further compression in the spring 14.

In the event that the piston 86 has been moved out of the seat 98 and the track tension subsequently drops to below the first range initial force 78 (FIG. 3), then the piston 86 (FIG. 4c) moves to the seat 98 and reseats itself. The tapered lead-in surface 96 permits the fluid 84 that is present in the space 108 to leave the space 108 before the piston 86 has formed a tight seal with the seat 98.

It will be noted that the second biasing means fluid 118 in the second biasing means fluid chamber 112 exerts a force on the second side 58 of the second piston 34 in addition to any force exerted through the piston engagement surface 62 on the second piston 34. The force exerted by the fluid 118 exists at all times, regardless of whether the piston engagement surface 62 is in contact with the sleeve engagement surface member 129. The force of the first biasing means fluid 31 will, of course, vary with the volume of the first biasing means fluid chamber 30.

The second piston 34 transmits the forces exerted on it by the piston engagement surface 62 and the second biasing means fluid 118 into the first-and-second-piston force transfer fluid 84 and over to the piston 86 through the fluid 84. In order that the piston 86 reseat itself reliably, the pressure of the first biasing means fluid 31 can be selected to overcome the force from the second biasing means fluid 118 through the second piston 34 and the first-and-second-piston force transfer fluid 84, and to overcome the frictional resistance between the seat 98 and the seal portion 94 of the piston 86 as the piston 86 reseats itself.

When the spring 14 is in the home position 61 (FIG. 3), if the compressive force on the spring 14 (FIG. 4b) decreases below the third range final force 70 (FIG. 3), then the spring 14 extends from the position shown in FIG. 4b, towards an equilibrium position shown in FIG. 4a. This reduces the likelihood that the track 12 (FIG. 1) will detrack from the wheels 16, 18 and 22 in the event of reduced track tension. As the spring 14 extends, the volume of the second biasing means fluid 118 (FIG. 4a) increases and accordingly reduces in pressure and force. An equilibrium position is found based on the specific track tension and fluid pressure.

The first range initial position 74 has been shown in FIG. 3 to correspond to a spring length of 760 mm (30″). This length, however, may be selected based on the particular properties of the spring 14 (FIG. 4b) and the vehicle 10 (FIG. 1) on which the spring 14 is to be used.

In the embodiment shown in FIG. 1, the track 12 may be made from a plurality of steel ‘shoes’ connected together. The track made with steel shoes may have some capability of stretching or contracting elastically to accommodate changes in the effective track path length that occur as a result of compression of the vehicle suspension, as a result of debris passing between the track 12 and one or more of the vehicle wheels 22, 16 and 18, or as a result of the acceleration or deceleration of the vehicle 10. The elastic range of length change for track 12 may be as high as, for example, 10%.

Alternatively, the track 12 may be made from a continuous band of material. Such a band track 12 may have a lower elastic range for length change than a track made from steel shoes. For example, a track 12 that is made from a continuous band may have an elastic range for length change of less than 1%. Additionally, the band may be made up of a few band segments, which are connected together and which facilitate installation of the band around the vehicle wheels 18, 16 and 22 and removal therefrom. Such a segmented band may have elasticity beyond 1% or may optionally not.

When a track 12 with little or no effective elastic range is used, such as a band track, the spring 14 can be used to provide a useful range of lengths of the effective track path and a range of track tensions that can be handled by the vehicle 10, involving compression of the suspension, debris between the wheels 22, 16 or 18 and the track 12, and acceleration/deceleration. When a track 12 with some elastic range is used (eg. a track made with steel shoes with an elastic range of, for example, 10%), the spring 14 can be used to increase the range of effective track path lengths and track tensions that the vehicle 10 can handle. This could permit the use of, for example, a suspension with an increased amount of travel, for example, which can be advantageous for the vehicle 10.

The spring 14 may be used on a vehicle 10 with either of the aforementioned types of track 12.

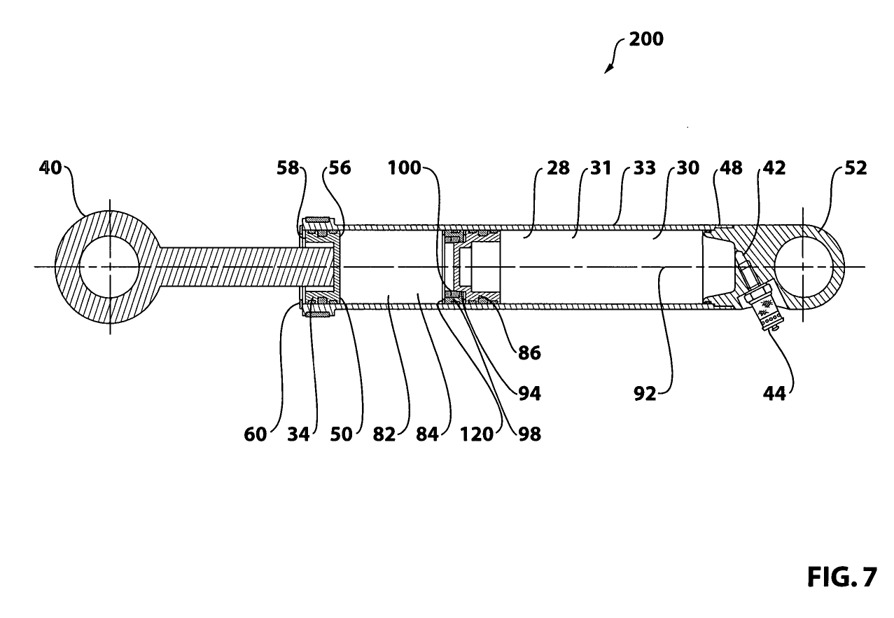

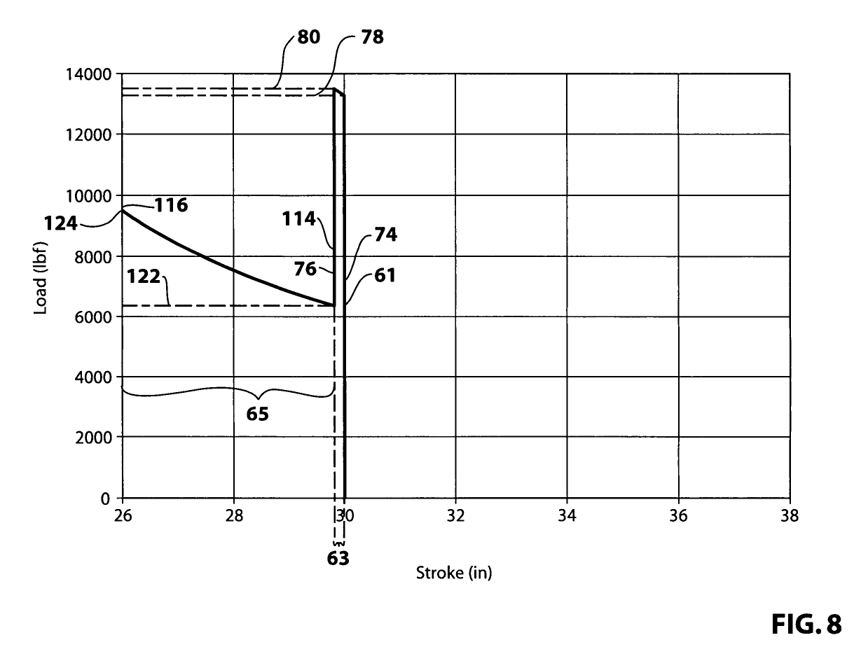

Reference is made to FIG. 7, which shows a spring 200 in accordance with another embodiment of the present invention. The spring 200 may be similar to the spring 14, except that the spring 200 lacks the sleeve 32 and the second biasing means 24. The response of the spring 200 to compressive forces is illustrated in the graph in FIG. 8. As can be seen in FIG. 8, the spring 200 (FIG. 7) has the first and second response zones 63 and 65, but lacks the third response zone 67 (FIG. 3). Thus, the position of the spring 200 in FIG. 7, in which the piston 86 is seated in the seat 98, corresponds to the extended position for the spring 200.

In this embodiment, the track 12 (FIG. 1) itself may be configured to have some capability of contracting in order to maintain contact with the wheels 22, 16 and 18 in the event of the suspension being compressed during use of the vehicle 10. Tracks 12 that are made from steel ‘shoes’ typically have some capability for elastic length change of several percent, which may be acceptable for some applications. When the vehicle 10 is at its normal suspension height, and is stationary, the track 12 may preferably be at or near its maximum length. In this way, the track 12 itself can provide the capability to contract, and the spring 200 (FIG. 7) can provide the movement necessary to accommodate debris passing between the track 12 (FIG. 1) and one or more of the wheels 22, 16 and 18.

The seal surface 94 (FIG. 4c) has been described as extending in a generally axial direction. In an alternative embodiment that is not shown, the seal surface 94 may be generally tapered and may mate with a similarly tapered seat seal surface 100 on the seat 98. By providing a tapered seal surface 94, as soon as the piston 86 moves away from the seat 98, the first-and-second-piston force transfer fluid 84 enters into contact with the entirety of the side 88 of the piston 86 and into contact with the second side 103 of the seat 98, and acts to reduce the force required to further compress the spring 14, 200.

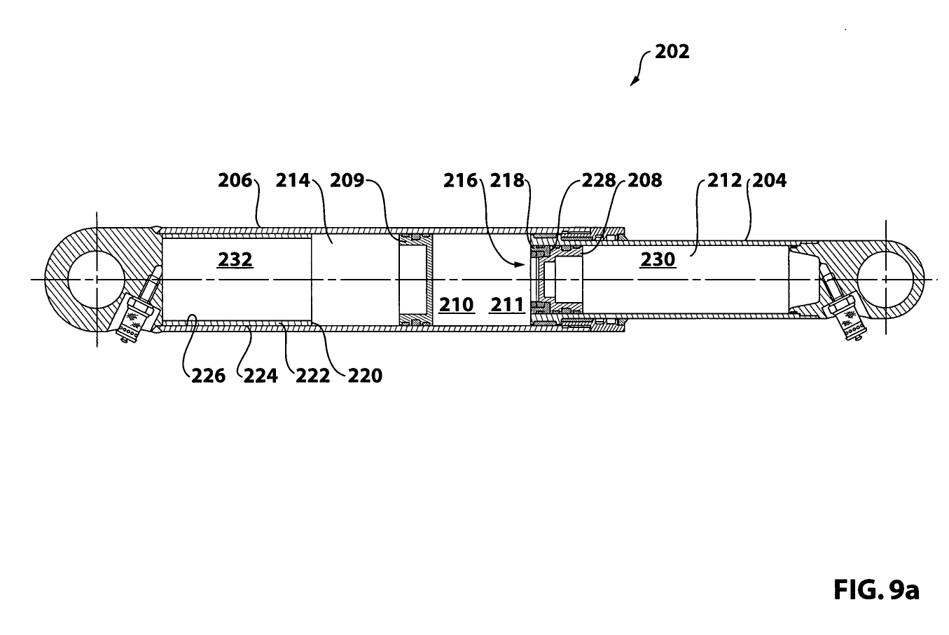

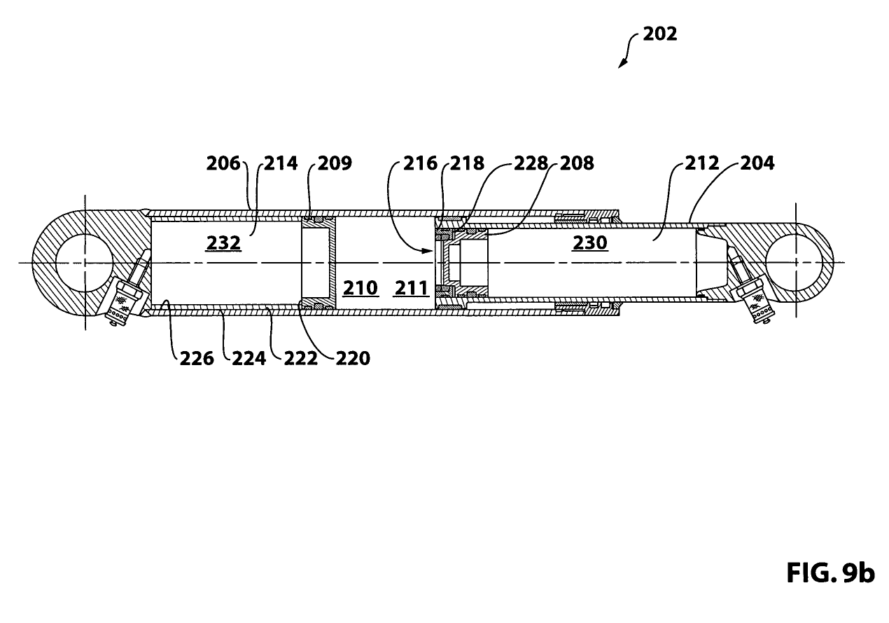

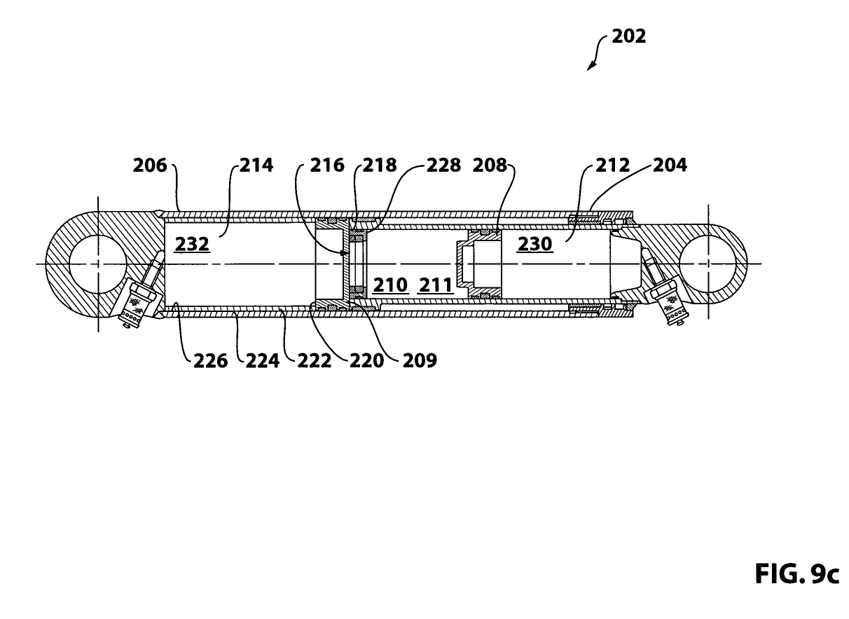

Reference is made to FIGS. 9a, 9b and 9c, which show a spring 202 in accordance with another embodiment of the present invention. The spring 202 has a first piston housing 204 and a sleeve 206, a first piston 208, a second piston 209, a first biasing means 212 and a second biasing means 214. A piston-to-piston chamber 210 is defined between the first and second pistons 208 and 209, for holding a first-and-second-piston force transfer fluid 211, which may be an incompressible fluid, such as a liquid. The spring 202 may be similar to the spring 14 (FIGS. 4a-4d), however the spring 202 has its first piston 208 at the open end of the housing 204. The open end is shown at 216. The second piston 209 is movable in the sleeve 206. If the length of the housing 204 is the same as the length of the housing 33 (FIG. 4a), then the position of the first piston 208 permits the spring 202 to have a greater available travel after the first piston 208 unseats from the seat member, shown at 218 at the open end 216 of the housing 204.

Alternatively, the spring 202 can be provided with a first piston housing 204 that is shorter than the housing 33 (FIG. 4a), while having an available travel after the unseating of the piston 208 that is similar to that of the spring 14 (FIG. 4a) after unseating of the piston 86.

The housing 204, sleeve 206, first piston 208, second piston 209, first biasing means 212 and second biasing means 214, may otherwise be similar to the housing 33, sleeve 32, first piston 86, second piston 34, first biasing means 28 and second biasing means 24 (FIGS. 4a-4d).

The sleeve 206 has a piston engagement surface 220 therein for engaging the second piston 209. Optionally, the piston engagement surface 220 may be positioned on a tubular member 222 that has an outer surface 224 that mates with the inner surface of the sleeve 206, shown at 226.

Because of the presence of the seat member 218, which has a limit surface 228 thereon, the first piston 208 is retained within the housing 204. As a result, and because the second piston 209 is not in the housing 204, the stop member 60 that is present on the housing 33 in the embodiment shown in FIG. 4a is not required.

As a result of the positions of the first and second pistons 208 and 209, the seal between the sleeve and the outer surface of the housing 204 is resistant to leakage of the fluid 211 that is present between the first and second pistons 208 and 209.

The movement of the spring 202 between the extended and compressed positions is illustrated by FIGS. 9a, 9b and 9c.

The spring 202 may incorporate the optional feature of using a remote reservoir which cooperates with the chamber shown at 230 that is part of the first biasing means 212. Additionally or alternatively, the spring 202 may incorporate the optional feature of using a remote reservoir which cooperates with the chamber shown at 232 that is part of the second biasing means 214.

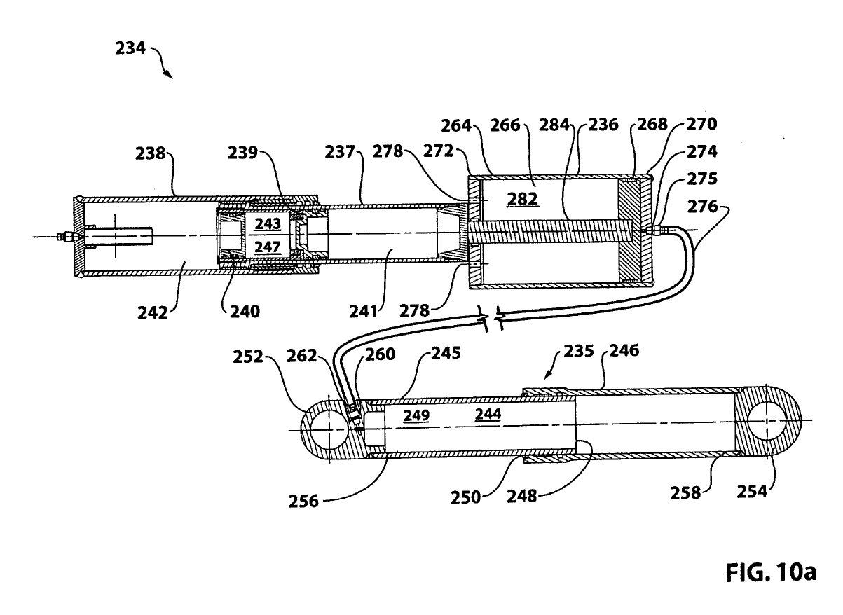

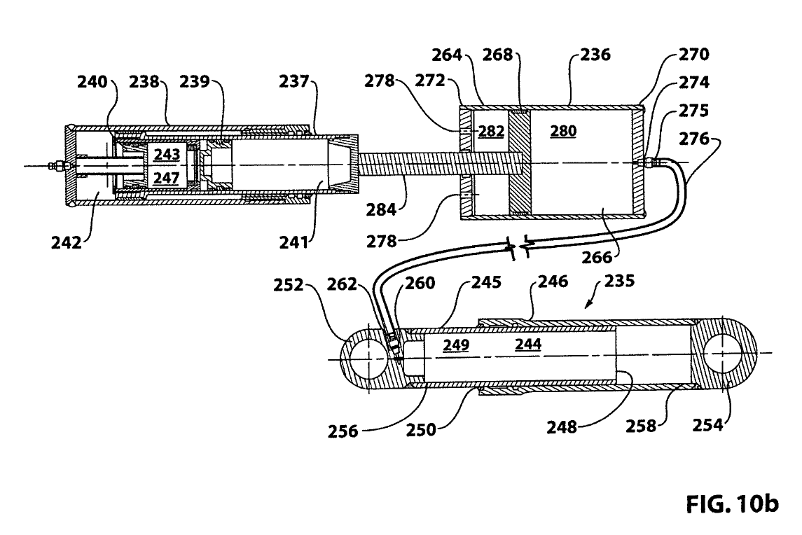

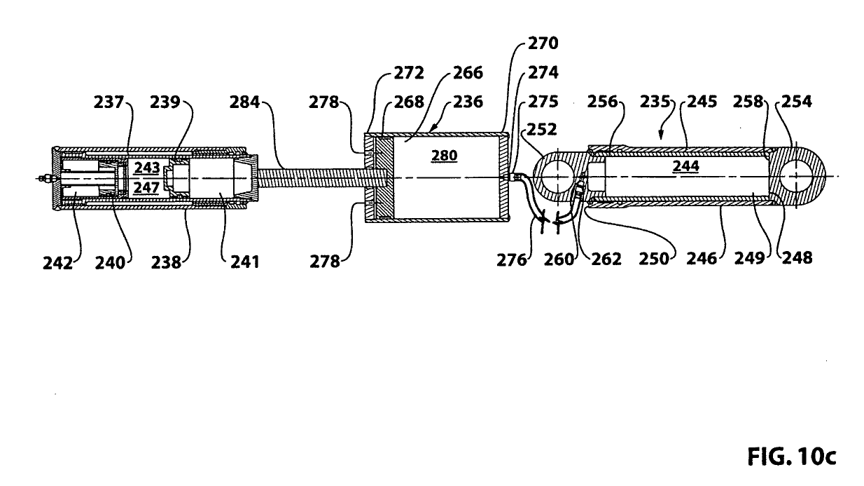

Reference is made to FIGS. 10a, 10b and 10c, which show a spring 234 in accordance with another embodiment of the present invention. The spring 234 includes a variable volume fluid vessel 235, a cylinder 236, a first piston housing 237, an optional sleeve 238, a first piston 239, a second piston 240, a first biasing means 241 and a second biasing means 242. A piston-to-piston chamber 243 is defined between the first and second pistons 239 and 240, for holding a first-and-second-piston force transfer fluid 247. The first-and-second-piston force transfer fluid 247 is preferably a substantially incompressible fluid, such as a liquid.

In the spring 234, only the variable volume fluid vessel 235 is positioned between the idler wheel support 23 and the vehicle frame 25 (FIG. 1a), while the other components of the spring 234, including the cylinder 236, the housing 237, the optional sleeve 238, the first piston 239, the second piston 240, the first biasing means 241 and the second biasing means 242, are all positioned in a remote location, where there may be less of a space constraint.

The variable volume fluid vessel 235 transfers forces from the idler wheel 16 (FIG. 1a) to the cylinder 236 and from the cylinder 236 to the idler wheel 16 (FIG. 1a). The variable volume fluid vessel 235 defines a variable volume vessel chamber 244 having a variable volume based on external forces acting thereon. The variable volume vessel chamber 244 is filled with a variable volume-fluid-vessel-and-cylinder force transfer fluid 249. The variable-volume-fluid-vessel-and-cylinder force transfer fluid 249 is preferably a substantially incompressible fluid, such as a liquid.

The variable volume fluid vessel 235 may have any suitable structure. For example, it may include a first housing portion 245 and a second housing portion 246. The first and second housing portions 245 and 246 have open ends 248 and 250 that are slidable with respect to each other while maintaining a seal with respect to each other to prevent leakage out of the chamber 244 of the fluid 249 contained therein.

First and second connectors 252 and 254 are provided on the closed ends of the housing portions 245 and 246. The closed ends form the first and second ends of the variable volume fluid vessel 235 and are shown at 256 and 258 respectively. The connectors 252 and 254 are for mounting the variable volume fluid vessel 235 between the idler wheel support 23 and the vehicle frame 25 (FIG. 1a). The connectors 252 and 254 may be mounting ears, as shown, in FIGS. 10a-10c. Alternatively, they may be any other suitable structure.

A port 260 may be provided proximate one of the closed ends 256 and 258 of the housing portions 245 and 246 to permit the chamber 244 to be filled with the fluid 249. A plug 262 is connected, preferably removably, to whichever housing portion 245 or 246 has the port 260, to close the port 260.

The cylinder 236 includes a cylinder housing 264 that defines a cylinder chamber 266, and a third piston 268, which is also be referred to as the cylinder piston 268. The housing 264 has a first end 270 and a second end 272. At the first end 270, the housing 264 has a first end port 274 with a plug 275 that is connected thereto, preferably removably. The first end port 274 is connected to the port 260 for the variable volume chamber 244 by a variable-volume-vessel-to-cylinder fluid conduit 276. The fluid conduit 276 may be any suitable conduit, such as a flexible hose. It is optionally possible to provide more than one first end port 274 and consequently more than one fluid conduit between the cylinder chamber 266 and the variable volume chamber 244.

At the second end 272, the housing 264 has at least one second end port 278. The at least one second end port 278 is open to atmosphere. For the purposes of this description, the term atmosphere means the ambient environment that is exterior to the cylinder 236.

The cylinder piston 268 seals against the housing 264 and is slidable within the housing 264 between a first position proximate the first end 270, shown in FIG. 10a and a second position proximate the second end 272, shown in FIG. 10c. The cylinder piston 268 divides the cylinder chamber 266 into a first end chamber 280 and a second end chamber 282 (see FIG. 10b in particular). The first end chamber 280 is in fluid communication with the variable volume chamber 244 through the fluid conduit 276.

The first end chamber 280, the fluid conduit 276 and the variable volume chamber 244 together form a closed system with respect to volume, which is filled with the fluid 249. Thus, as the volume of the first end chamber 280 is reduced, ie. during movement of the cylinder piston 268 towards the position shown in FIG. 10a, some or substantially all of the fluid 249 contained in the first end chamber 280 is moved to the variable volume chamber 244 which urges the first and second housing portions 245 and 246 apart. Conversely, as the volume of the variable volume chamber 244 is reduced, ie. during an event that occurs to the vehicle that causes a compressive force on the first and second housing portions 245 and 246, fluid 249 is urged towards the cylinder chamber 266 which urges the cylinder piston 268 toward the second end 272 of the cylinder housing 264.

The second end chamber 282 remains substantially at the pressure of the ambient air outside the cylinder 236 throughout the movement of the cylinder piston 268 between the positions shown in FIGS. 10a and 10c as a result of the one or more second end ports 278.

A connecting arm 284 extends from the cylinder piston 268 out through the second end 272 of the housing 264 and over to the housing 237. The housing 237, the optional sleeve 238, the first piston 239, the second piston 240, the first biasing means 241 and the second biasing means 242 may be similar to the housing 33, the optional sleeve 32, the first piston 86, the second piston 34, the first biasing means 28 and the second biasing means 24, shown in FIGS. 4a-4d. Some differences may be present however.

One difference is that the overall travel of the housing 237 and sleeve 238 relative to each other during extension and contraction of the variable volume fluid vessel 235 may be controlled to some extent by the ratio of the cross sectional area of the cylinder chamber 266 to the cross sectional area of the variable volume chamber 244 of the fluid vessel 235. The cross-sectional area of the cylinder chamber 266 is the area in a plane that is perpendicular to the direction of travel of the cylinder piston 268. The cross-sectional area of the variable volume chamber 244 is the area in a plane that is perpendicular to the direction of travel of the first and second housing portions 245 and 246 during expansion and contraction of the fluid vessel 235.

For example, if the cross-sectional area of the cylinder chamber 266 is twice the cross-sectional area of the variable volume chamber 244, then a selected amount of travel for the cylinder piston 268 translates into twice as much travel for the first and second housing portions 245 and 246 relative to each other. As a result, the housing 237 and sleeve 238 may require less or more travel relative to each other than the housing 33 and sleeve 32 require (see FIGS. 4a-4d).

Another difference that may be present is that the housing 237 does not need to include connectors, since it is connected to the cylinder piston 268 via the connecting arm 284.

The housing 237, the optional sleeve 238, the first piston 239, the second piston 240, the first biasing means 241 and the second biasing means 242 may alternatively be similar to the housing 204, the optional sleeve 206, the first piston 208, the second piston 209, the first biasing means 212 and the second biasing means 214 shown in FIGS. 9a, 9b and 9c, except for the distinctions noted above regarding the spring 234, in relation to the overall travel for the spring 234 and to the lack of need for the presence of connectors on the housing 237.

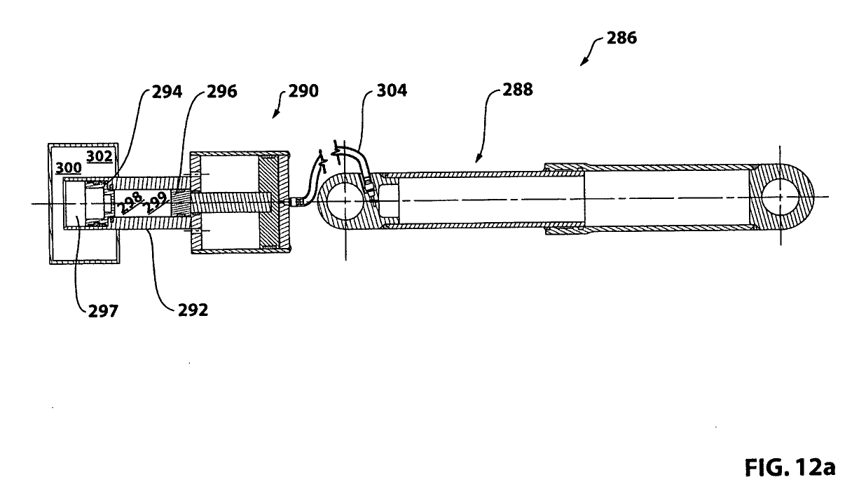

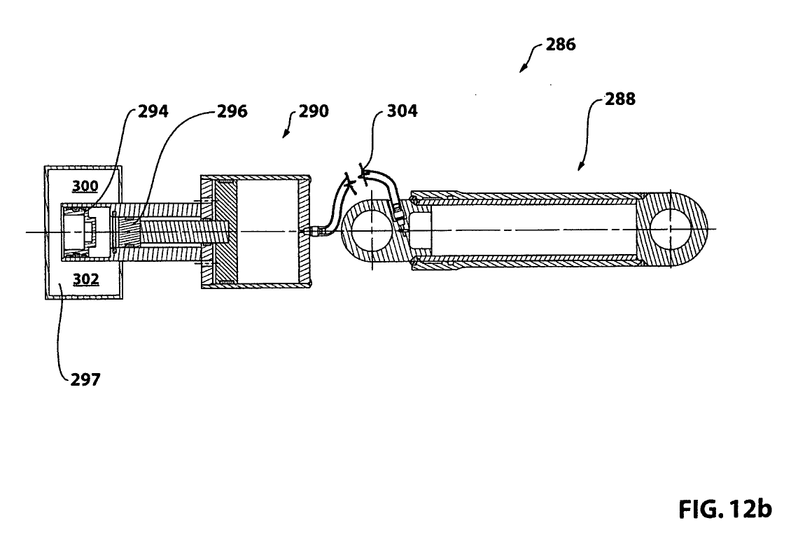

Reference is made to FIGS. 12a and 12b, which show a multi-stage spring 286 in accordance with another embodiment of the present invention. The spring 286 may be similar to the spring 200 shown in FIG. 7, in that it may have a first and second response zone similar to the first and second response zones shown in FIG. 8, however, the spring 286 includes a variable volume fluid vessel 288 and a cylinder 290 which may be similar to the fluid vessel 235 and the cylinder 236 shown in FIGS. 10a, 10b and 10c.

The spring 286 includes a first piston housing 292, a first piston 294, a second piston 296 and a first biasing means 297. A piston-to-piston chamber 298 is defined between the first and second pistons 294 and 296, for holding a piston-to-piston force transfer fluid 299, which may be an incompressible fluid, such as a liquid. In the spring 286, only the variable volume fluid vessel 288 is positioned between the idler wheel support 23 and the vehicle frame 25 (FIG. 1a), while the other components of the spring 286, including the cylinder 290, the housing 292, the first piston 294, the second piston 296 and the first biasing means 297, are all positioned in a remote location, where there may be less of a space constraint.

The housing 292 may be similar to the housing 33 (FIGS. 4a-4d), however the housing 292 is be connected to the cylinder 290. Additionally, the housing 292 may also be configured to include a first biasing means fluid chamber 300 instead of the first biasing means fluid chamber 30 (FIGS. 4a-4d) in the region that is fluidically on a selected side of the first piston 294. The chamber 300 may be wider than the rest of the housing 300. This permits some control over the amount of travel of the first piston 294 when compressing or expanding the compressible first biasing means fluid, shown at 302 in the chamber 300 as part of the first biasing means 198. This control is provided even in a situation wherein the overall length of the housing 300 is limited by a space constraint of some kind.

The first piston 294, the second piston 296 may be similar to the first and second pistons 86 and 34 (FIGS. 4a-4d).

The variable volume fluid vessel 288 may be similar to the variable volume fluid vessel 235 shown in FIGS. 10a-10c. The cylinder 290 may be similar to the cylinder 236 shown in FIGS. 10a-10c. A fluid conduit 304 connects the variable volume fluid vessel 288 and the cylinder 290.

The tracked vehicle 10 may be any suitable tracked vehicle and is not limited to the type of tracked vehicle shown in FIG. 1.

As will be apparent to persons skilled in the art, various modifications and adaptations of the apparatus described above may be made without departure from the present invention, the scope of which is defined in the appended claims.

1. A multi-stage spring for a track tensioner for a tracked vehicle, wherein the multi-stage spring has a rest position associated therewith, wherein the multi-stage spring is positionable in a first range of positions, a second range of positions and a third range of positions, wherein the first range of positions is closer to the rest position than is the second range of positions, and wherein the third range of positions is closer to the rest position than is the first range of positions,
wherein the multi-stage spring is movable from an initial position in the first range of positions in a direction away from the rest position by a first range initial force,
and wherein the multi-stage spring is movable from an initial position in the second range of positions in the direction away from the rest position by a second range initial force, wherein the first range initial force is greater than the second range initial force,
and wherein the multi-stage spring is movable in the third range of positions to a third range final position by a third range final force, wherein the first range initial force is greater than the third range final force.

2. A multi-stage spring as claimed in claim 1, wherein the multi-stage spring comprises a first piston housing, a first piston and a second piston,
wherein the first piston is slidable in the first piston housing and wherein the second piston is slidable, and wherein a piston-to-piston chamber is defined between the first and second pistons, wherein the piston-to-piston chamber is filled with a first-and-second-piston force transfer fluid, wherein the first-and-second-piston force transfer fluid is substantially incompressible,
wherein the first piston has a chamber-facing side, wherein the first piston housing includes a seat for receiving the first piston, wherein the seat is sized to cover a first selected surface portion of the chamber-facing side when the first piston is received in the seat and to leave a second selected surface portion of the surface area of the chamber exposed to the piston-to-piston force transfer fluid in the piston-to-piston chamber,
wherein when the first piston is outside of the seat, both the first and second selected surface portions of the chamber-facing side are exposed to the piston-to-piston force transfer fluid in the piston-to-piston chamber.

3. A multi-stage spring as claimed in claim 2,
wherein the multi-stage spring has a first end and a second end,
and wherein the multi-stage spring comprises a first biasing means, wherein the first biasing means urges the first piston towards the seat and away from the first end,
and wherein the multi-stage spring comprises a second biasing means, wherein the second biasing means urges the second piston away from the second end and urges the first piston housing away from the second end.

4. A multi-stage spring as claimed in claim 3,
wherein the multi-stage spring includes a limit surface for engaging the second piston to prevent the travel of the second piston past a selected position,
wherein when the second piston is in the selected position and the first piston is seated in the seat, the multi-stage spring is in the initial position for the first range of positions.

5. A multi-stage spring as claimed in claim 3,
wherein the second biasing means exerts a force through the second piston, through the first-and-second force transfer fluid in the piston-to-piston chamber and on the first piston in a direction away from the seat,
and wherein when the first piston is proximate the seat, the first biasing means exerts a greater force on the first piston towards the seat than is exerted by the second biasing means away from the seat.

6. A multi-stage spring as claimed in claim 3, wherein the second biasing means includes a sleeve that is slidable with respect to the housing, wherein a second biasing means fluid chamber is defined at least partially by the sleeve and the second piston, wherein the second biasing means fluid chamber is filled with a second biasing means fluid, wherein the second biasing means fluid is compressible.

7. A multi-stage spring as claimed in claim 6, wherein the second biasing means further includes a second biasing means remote reservoir, wherein the second biasing means remote reservoir is fluidically connected to the second biasing means fluid chamber by a fluid conduit.

8. A multi-stage spring as claimed in claim 6, wherein a first biasing means fluid chamber is defined by the housing and the first piston, wherein the first biasing means fluid chamber is filled with a first biasing means fluid wherein the first biasing means fluid is compressible.

9. A multi-stage spring as claimed in claim 8, wherein the first biasing means further includes a first biasing means remote reservoir, wherein the first biasing means remote reservoir is fluidically connected to the first biasing means fluid chamber by a fluid conduit.

10. A multi-stage spring as claimed in claim 8,
wherein the first biasing means further includes a first biasing means remote reservoir, wherein the first biasing means remote reservoir is fluidically connected to the first biasing means fluid chamber by a first biasing means fluid conduit,
and wherein the second biasing means further includes a second biasing means remote reservoir, wherein the second biasing means remote reservoir is fluidically connected to the second biasing means fluid chamber by a second biasing means fluid conduit.

11. A multi-stage spring as claimed in claim 3, wherein the multi-stage spring further comprises a first connector at the first end for connecting to the tracked vehicle, and a second connector at the second end for connecting to the tracked vehicle.

12. A multi-stage spring as claimed in claim 3,
wherein the multi-stage spring further comprises a cylinder, wherein the cylinder includes a cylinder housing, a cylinder piston and a connecting arm, wherein the cylinder piston is movable within the cylinder housing, wherein the connecting arm connects the cylinder piston to the housing, wherein the cylinder has a first end, and wherein the cylinder has a second end that is open to atmosphere,
and wherein the multi-stage spring further comprises a variable volume fluid vessel, wherein the variable volume fluid vessel has a volume that is variable based on external forces acting thereon, wherein the variable volume fluid vessel is filled with a variable-volume-fluid-vessel-and-cylinder force transfer fluid, wherein the variable-volume-fluid-vessel-and-cylinder force transfer fluid is substantially incompressible, and wherein the variable volume fluid vessel is fluidically connected to the first end of the cylinder housing,
wherein the variable volume fluid vessel has a first end and a second end, and wherein the multi-stage spring further comprises a first connector at the first end of the variable volume fluid vessel for connecting to the tracked vehicle, and a second connector at the second end variable volume fluid vessel for connecting to the tracked vehicle.

13. A multi-stage spring as claimed in claim 2,
wherein the second piston is slidable outside of the first piston housing and within a sleeve, wherein the sleeve is slidable with respect to the housing.

14. A multi-stage spring as claimed in claim 2,
wherein the second piston is slidable within the first piston housing.

15. A multi-stage spring for a track tensioner for a tracked vehicle, wherein the multi-stage spring has a rest position associated therewith, wherein the multi-stage spring is positionable in a first range of positions, a second range of positions and a third range of positions, wherein the first range of positions is closer to the rest position than is the second range of positions, and wherein the third range of positions is closer to the rest position than is the first range of positions,
wherein in the first range of positions the multi-stage spring exerts a resistive force to movement in a direction away from the rest position that increases with distance away from the rest position from a first range initial force to a first range final force,
and wherein in the second range of positions the multi-stage spring exerts a resistive force to movement in a direction away from the rest position that increases linearly with distance away from the rest position from a second range initial force to a second range final force,
and wherein in the third range of positions the multi-stage spring exerts a resistive force to movement in a direction away from the rest position that increases linearly with distance away from the rest position from a third range initial force to a third range final force,
and wherein the first range initial force is greater than the second range initial force and the third range final force.

16. A multi-stage spring as claimed in claim 15, wherein the multi-stage spring comprises a first piston housing, a first piston and a second piston,
wherein the first piston is slidable in the first piston housing and wherein the second piston is slidable, and wherein a piston-to-piston chamber is defined between the first and second pistons, wherein the piston-to-piston chamber is filled with a first-and-second-piston force transfer fluid, wherein the first-and-second-piston force transfer fluid is substantially incompressible,
wherein the first piston has a chamber-facing side, wherein the first piston housing includes a seat for receiving the first piston, wherein the seat is sized to cover a first selected surface portion of the chamber-facing side when the first piston is received in the seat and to leave a second selected surface portion of the surface area of the chamber exposed to the piston-to-piston force transfer fluid in the piston-to-piston chamber,
wherein when the first piston is outside of the seat, both the first and second selected surface portions of the chamber-facing side are exposed to the piston-to-piston force transfer fluid in the piston-to-piston chamber.

17. A multi-stage spring as claimed in claim 16,
wherein the multi-stage spring has a first end and a second end,
and wherein the multi-stage spring comprises a first biasing means, wherein the first biasing means urges the first piston towards the seat and away from the first end,
and wherein the multi-stage spring comprises a second biasing means, wherein the second biasing means urges the second piston away from the second end and urges the first piston housing away from the second end.

18. A multi-stage spring as claimed in claim 17,
wherein the multi-stage spring includes a limit surface for engaging the second piston to prevent the travel of the second piston past a selected position,
wherein when the second piston is in the selected position and the first piston is seated in the seat, the multi-stage spring is in the initial position for the first range of positions.

19. A multi-stage spring as claimed in claim 17,
wherein the second biasing means exerts a force through the second piston, through the first-and-second force transfer fluid in the piston-to-piston chamber and on the first piston in a direction away from the seat,
and wherein when the first piston is proximate the seat, the first biasing means exerts a greater force on the first piston towards the seat than is exerted by the second biasing means away from the seat.

20. A multi-stage spring as claimed in claim 17, wherein the second biasing means includes a sleeve that is slidable with respect to the housing, wherein a second biasing means fluid chamber is defined at least partially by the sleeve and the second piston, wherein the second biasing means fluid chamber is filled with a second biasing means fluid, wherein the second biasing means fluid is compressible.

21. A multi-stage spring as claimed in claim 20, wherein the second biasing means further includes a second biasing means remote reservoir, wherein the second biasing means remote reservoir is fluidically connected to the second biasing means fluid chamber by a fluid conduit.

22. A multi-stage spring as claimed in claim 20, wherein a first biasing means fluid chamber is defined by the housing and the first piston, wherein the first biasing means fluid chamber is filled with a first biasing means fluid wherein the first biasing means fluid is compressible.

23. A multi-stage spring as claimed in claim 22, wherein the first biasing means further includes a first biasing means remote reservoir, wherein the first biasing means remote reservoir is fluidically connected to the first biasing means fluid chamber by a fluid conduit.

24. A multi-stage spring as claimed in claim 22,
wherein the first biasing means further includes a first biasing means remote reservoir, wherein the first biasing means remote reservoir is fluidically connected to the first biasing means fluid chamber by a first biasing means fluid conduit,
and wherein the second biasing means further includes a second biasing means remote reservoir, wherein the second biasing means remote reservoir is fluidically connected to the second biasing means fluid chamber by a second biasing means fluid conduit.

25. A multi-stage spring as claimed in claim 17, wherein the multi-stage spring further comprises a first connector at the first end for connecting to the tracked vehicle, and a second connector at the second end for connecting to the tracked vehicle.

26. A multi-stage spring as claimed in claim 17,
wherein the multi-stage spring further comprises a cylinder, wherein the cylinder includes a cylinder housing, a cylinder piston and a connecting arm, wherein the cylinder piston is movable within the cylinder housing, wherein the connecting arm connects the cylinder piston to the housing, wherein the cylinder has a first end, and wherein the cylinder has a second end that is open to atmosphere,
and wherein the multi-stage spring further comprises a variable volume fluid vessel, wherein the variable volume fluid vessel has a volume that is variable based on external forces acting thereon, wherein the variable volume fluid vessel is filled with a variable-volume-fluid-vessel-and-cylinder force transfer fluid, wherein the variable-volume-fluid-vessel-and-cylinder force transfer fluid is substantially incompressible, and wherein the variable volume fluid vessel is fluidically connected to the first end of the cylinder housing,
wherein the variable volume fluid vessel has a first end and a second end, and wherein the multi-stage spring further comprises a first connector at the first end of the variable volume fluid vessel for connecting to the tracked vehicle, and a second connector at the second end variable volume fluid vessel for connecting to the tracked vehicle.

27. A multi-stage spring as claimed in claim 16,
wherein the second piston is slidable outside of the first piston housing and within a sleeve, wherein the sleeve is slidable with respect to the housing.

28. A multi-stage spring as claimed in claim 16,
wherein the second piston is slidable within the first piston housing.
